(19) United States
(12) Patent Application Publication
(10) Pub. No.: US 2015/0195642 A1
(43) Pub. Date: Jul. 9, 2015

(54) POWER TRANSFERRING HEADPHONES

(71) Applicant: Zeikos Inc., Edison, NJ (US)

(72) Inventor: Isaac Saideh, Edison, NJ (US)

(21) Appl. No.: 14/665,619

(22) Filed: Mar. 23, 2015

Related U.S. Application Data
(63) Continuation-in-part of application No. 14/533,718, filed on Nov. 5, 2014.
Application No. 14/533,718 is a continuation-in-part of application No. 14/071,223, filed on Nov. 4, 2013, now Pat. No. 8,923,525.
Application No. 14/071,223 is a continuation of application No. 13/760,765, filed on Feb. 6, 2013, now abandoned.
Application No. 13/760,765 is a continuation-in-part of application No. 29/483,095, filed on Feb. 25, 2014.
Application No. 29/483,095 is a continuation of application No. 29/473,402, filed on Nov. 21, 2013, now Pat. No. D722996.

(51) Int. Cl. H04R 1/10

(52) U.S. Cl. CPC H04R 1/1091; H04R 2201/109

(57) ABSTRACT

The invention relates to headphones which can facilitate the transfer of electrical power from the headphones' internal power source to other devices. A pair of headphones can connect to a device through a modified cable. The modified cable triggers the transfer of electrical power to the device. A pair headphones may have a modified port which, when connected to the device through a non-modified or regular cable, causes the transfer of power from the headphones. A power management component connected to the internal power source of the headphones helps control or regulate the transfer of power transfer to and from the headphones.

### CROSS-REFERENCE TO RELATED APPLICATION

This application is a Continuation-in-Part of U.S. patent application Ser. No. 14/533,718, filed on Nov. 5, 2014, which is a Continuation-in-Part of U.S. patent application Ser. No. 14/071,223, filed on Nov. 4, 2013 (now U.S. Pat. No. 8,923,525), which is a Continuation of U.S. patent application Ser. No. 13/760,765, filed on Feb. 6, 2013 (now abandoned), the entire contents of each of which are incorporated by reference herein. This application is also a Continuation-In-Part of U.S. Design patent application Ser. No. 29/483,095, filed on Feb. 25, 2014, which is a Continuation of U.S. Design patent application Ser. No. 29/473,402, filed on Nov. 21, 2013, the entire contents of each of which are incorporated by reference herein.

### FIELD

The present disclosure generally relates to headphones which can transfer electrical power from the headphones to an external device.

### SUMMARY

The present disclosure generally relates to headphones which can transfer electrical power from the headphones to an external device.

In exemplary embodiments, a pair of headphones is disclosed, comprising a first speaker unit configured to provide audio output and comprising an internal power source, a second speaker unit configured to provide audio output, a port, an internal digital-to-analog converter located on one of the first speaker unit and the second speaker unit, and an internal power management component. The second speaker unit is electronically connected with the first speaker unit, and the first speaker unit and the second speaker unit are physically connected with a band. The port is in electrical communication with the internal power source and configured to receive electronic data. The internal digital-to-analog converter is disposed within one of the first speaker unit and the second speaker unit and is electronically connected between the port and the first and second speaker units. The internal power management component is disposed within one of the first speaker unit and the second speaker unit and is operatively connected between the internal power source and the port to direct electrical power to flow from the internal power source to an external electronic device that is electronically connected to one of the first speaker unit and the second speaker unit via the port while simultaneously directing electrical power to flow from the internal power source to one or more other powered components of the headphones. The port is configured to transmit electrical power and receive electronic data simultaneously.

In embodiments, the one or more other powered components comprises a wireless communication receiver.

In embodiments, the one or more other powered components comprises an amplifier.

In embodiments, the amplifier is configured to apply a voltage gain to an input electrical signal along a frequency range of 20 Hz to 20,000 Hz.

In embodiments, the amplifier is configured to apply a voltage gain to an input electrical signal along a frequency range of 20 Hz to 500 Hz.

In embodiments, the internal power management component is configured to control an output voltage of the internal power source.

In embodiments, the internal power management component is configured to determine an amount of electrical power in the internal power source.

In embodiments, the internal power management component is configured to prevent electrical power from flowing through the port if the internal power source is below a predetermined threshold level.

In embodiments, the port is configured to receive a portion of a power transferring cable.

In embodiments the port is configured as one of the group comprising: a USB-A port, a mini USB-A port, a micro USB-A port, a USB-B port, a mini USB-B port, a micro USB-B port, and a Lightning Port.

In embodiments, the port is configured to receive electronic data associated with audio content.

In embodiments, the one or more powered components of the headphones comprises a noise-cancellation component.

In embodiments, the noise cancellation component is configured to produce an electrical signal with an inverse waveform of a target noise.

In embodiments, the power management component is a digital signal processor.

In embodiments, the power management component is configured to apportion a predetermined amount of electrical power to an external electronic device electrically coupled with the port.

In embodiments, the one or more other powered components are selected from the group comprising: a low-frequency amplifier, a wide spectrum amplifier, a wireless communication receiver, a noise-cancellation component, and the internal digital-to-analog converter.

In exemplary embodiments, a pair of headphones is disclosed, comprising a first speaker unit configured to provide audio output and comprising an internal power source, a second speaker unit configured to provide audio output, a port, a wireless communication receiver located on one of the first speaker unit and the second speaker unit, and an internal power management component. The second speaker unit is electronically connected with the first speaker unit, and the first speaker unit and the second speaker unit are physically connected with a band. The port is in electrical communication with the internal power source and configured to receive electronic data. The wireless communication receiver is disposed within one of the first speaker unit and the second speaker unit and is electronically connected to the internal power source. The internal power management component is disposed within one of the first speaker unit and the second speaker unit and is operatively connected between the internal power source and the port to direct electrical power to flow from the internal power source to an external electronic device that is electronically connected to one of the first speaker unit and the second speaker unit via the port while simultaneously directing electrical power to flow from the internal power source to one or more other powered components of the headphones.

In embodiments, the one or more other powered components of the headphones comprises an amplifier.

In embodiments, the one or more other powered components of the headphones comprises a noise-cancellation component.

In embodiments, the one or more other powered components of the headphones comprises an internal digital-to-analog converter.

In embodiments, the one or more other powered components are selected from the group comprising: a low-frequency amplifier, a wide spectrum amplifier, the wireless communication receiver, a noise-cancellation component, and an internal digital-to-analog converter.

In exemplary embodiments, a pair of headphones is disclosed, comprising a first speaker unit configured to provide audio output and comprising an internal power source, a second speaker unit configured to provide audio output, a port, a noise-cancellation component electronically connected to the internal power source, and an internal power management component. The second speaker unit is electronically connected with the first speaker unit, and the first speaker unit and the second speaker unit are physically connected with a band. The port is in electrical communication with the internal power source and configured to receive electronic data. The noise-cancellation component is disposed within one of the first speaker unit and the second speaker unit and is electronically connected to the internal power source. The internal power management component is disposed within one of the first speaker unit and the second speaker unit and is operatively connected between the internal power source and the port to direct electrical power to flow from the internal power source to an external electronic device that is electronically connected to one of the first speaker unit and the second speaker unit via the port while simultaneously directing electrical power to flow from the internal power source to one or more other powered components of the headphones.

In embodiments, the one or more other powered components of the headphones comprises an amplifier.

In embodiments, the one or more other powered components of the headphones comprises a wireless communication receiver.

In embodiments, the one or more other powered components of the headphones comprises an internal digital-to-analog converter.

In embodiments, the one or more other powered components are selected from the group comprising: a low-frequency amplifier, a wide spectrum amplifier, a wireless communication receiver, the noise-cancellation component, and an internal digital-to-analog converter.

### DESCRIPTION OF THE DRAWINGS

The features and advantages of the present disclosure will be more fully understood with reference to the following, detailed description when taken in conjunction with the accompanying figures, wherein:

FIG. 1A is a perspective view of a pair of headphones with an associated external device according to an exemplary embodiment of the present invention.

FIG. 1B is a front view of the headphones of FIG. 1A.

FIG. 1C is a rear view of the headphones of FIG. 1A.

FIG. 1D is a side view of the headphones of FIG. 1A.

FIG. 1E is a side view of the headphones of FIG. 1A opposite the side view shown in FIG. 1D.

FIG. 1F is a top plan view of the headphones of FIG. 1A.

FIG. 1G is a bottom plan view of the headphones of FIG. 1A shown connected to the external device.

FIG. 1H is a perspective view of the headphones of FIG. 1A according to an alternative embodiment of the present invention.

FIG. 2 is a schematic diagram of the pair of headphones of FIG. 1A connected with the external device.

FIG. 3 illustrates a pair of headphones according to an exemplary embodiment of the present invention.

FIG. 4 illustrates cables used for transferring power according to an exemplary embodiment of the present invention.

FIG. 5 illustrates a pair of headphones according to an exemplary embodiment of the present invention.

FIG. 6A is a perspective view of a pair of headphones and an associated external device according to an exemplary embodiment of the present invention.

FIG. 6B is a bottom plan view of the headphones of FIG. 6A.

FIG. 6C is an electrical circuit diagram of a configuration of an amplifier of the headphones of FIG. 6A according to an exemplary embodiment of the present invention.

FIG. 6D is an electrical circuit of a configuration of another amplifier of the headphones of FIG. 6A according to an exemplary embodiment of the present invention.

FIG. 6E is a schematic diagram of an electrical configuration of the pair of headphones of FIG. 6A according to an exemplary embodiment of the present invention.

FIG. 6F is an electrical circuit diagram of a configuration of the pair of headphones of FIG. 6A including a power management component according to an exemplary embodiment of the present invention.

FIG. 7A is a perspective view of a pair of headphones and an associated external electronic device according to an exemplary embodiment of the present invention.

FIG. 7B is a bottom plan view of the pair of headphones of FIG. 7A.

FIG. 7C is a schematic diagram of a configuration of various components of the pair of headphones of FIG. 7A.

FIG. 8A is a perspective view of a pair of headphones and an associated external electronic device according to an exemplary embodiment of the present invention.

FIG. 8B is a bottom plan view of the pair of headphones of FIG. 8A.

FIG. 8C is a schematic diagram of various components of the pair of headphones of FIG. 8A.

FIG. 9A is a perspective view of a pair of headphones and an associated external electronic device according to an exemplary embodiment of the present invention.

FIG. 9B is a bottom plan view of the pair of headphones of FIG. 9A.

FIG. 9C is a schematic diagram of various components of the pair of headphones of FIG. 9A.

FIG. 10A is a perspective view of a pair of headphones and an associated external electronic device according to an exemplary embodiment of the present invention.

FIG. 10B is a bottom plan view of the pair of headphones of FIG. 10A.

FIG. 10C is a schematic diagram of various components of the pair of headphones of FIG. 10A.

### DETAILED DESCRIPTION

The present invention generally relates to audio headphones and associated methods of configuration and use for transferring electrical power from a pair of headphones to a connected external device. The drawing figures are not necessarily drawn to scale and certain figures may be shown in exaggerated or generalized form in the interest of clarity and conciseness.

In an exemplary embodiment, a headphone device is disclosed that comprises a first speaker unit for providing audio output, a second speaker unit for providing audio output, an internal power source, one or more powered components electrically coupled with the internal power source, a port, and an internal power management component. The second speaker unit is connected to the first speaker unit with a band. The internal power source is disposed in an interior portion of the headphone device, and the one or more powered components are electrically coupled with the internal power source to receive electrical power from the internal power source. The port is located on one of the first speaker unit and the second speaker unit, and is in electrical communication with the internal power source. The internal power management component is connected between the internal power source and the port, and is configured to cause electrical power to flow from the internal power source through the port.

In embodiments, the one or more powered components comprise a wireless communication receiver.

In embodiments, the one or more powered components comprise an amplifier.

In embodiments, the internal power management component is configured to control an output voltage of the internal power source.

In embodiments, the port is configured to receive a first end of an electrical cable with a second end connectable to an external device.

In embodiments, the port is configured to receive a first end of an electrical cable with a second end connectable to a power adaptor for providing power from a wall outlet to charge the internal power source.

In embodiments, a data pin of the first end of the electrical cable is electrically grounded.

In embodiments, a data pin of the first end of the electrical cable is electrically shorted.

In embodiments, the electrical cable further comprises a removable adaptor at the first end of the electrical cable for electrically grounding a data pin of the electrical cable.

In embodiments, the electrical cable further comprises a removable adaptor at the end of the electrical cable for electrically shorting a data pin of the electrical cable.

In embodiments, the power management component is configured to determine the amount of electrical power in the internal power source and prevents the transfer of electrical power from the internal power source if the amount of electrical power is less than or equal to a predefined threshold electrical power level.

In embodiments, the internal power source comprises one or more rechargeable batteries.

In embodiments, the internal power source comprises one or more disposable batteries.

In embodiments, the power management component comprises a power manager integrated circuit.

In embodiments, the port is a USB-type port for receiving a USB-type cable.

In embodiments, the USB type port is a micro USB port and the USB-type cable has at least one micro USB-type connector.

In embodiments, the one or more powered components comprise a wireless communication transmitter.

In embodiments, the one or more powered components comprise a wireless communication transceiver.

In embodiments, the one or more powered components comprise an amplifier.

In embodiments, the amplifier continuously receives electrical power from the internal power source.

In embodiments, the amplifier is configured to apply a voltage gain to an input electrical signal along a frequency range of 20 Hz to 20,000 Hz.

In embodiments, the amplifier is configured to apply a voltage gain along a frequency range of 20 Hz to 500 Hz.

In an exemplary embodiment, a pair of headphones may include a left speaker unit including a left speaker for providing audio output; a right speaker unit including a right speaker for providing audio output; an adjustable band configured to hold the left speaker unit and the right speaker unit; a port located on one of the speaker units, the port operatively connected to an internal power source of the headphones; and a power management component for regulating the internal power source of the headphones so that when a first cable is connected to the port and to an external device electrical power is transferred to the external device, and when a power adaptor is connected to the port and to a wall outlet, the internal power source is being charged.

In some exemplary embodiments, the data pin of the connecting end of the first cable may be electrically grounded.

In some exemplary embodiments, the data pin of the connecting end of the first cable may be electrically shorted.

In some exemplary embodiments, the first cable may also include a removable adaptor at the end of the first cable connecting to the port, the connector electrically grounding a data pin of the first cable.

In some exemplary embodiments, the first cable may also include a removable adaptor at the end of the first cable connecting to the port, the connector electrically shorting a data pin of the first cable.

In some exemplary embodiments, the power management component of the headphones may determines the amount of power in the internal power source and prevents the transfer of power from the internal power source if the amount of power is less than or equal to a predefined threshold power level.

In some exemplary embodiments, the integral power source may be one or more rechargeable batteries.

In some exemplary embodiments, the power management component may be a power manager integrated circuit. For example, the integrated circuit may be a Linear Chip LTC4160.

In some exemplary embodiments, port may be a USB type port and the first cable may be a USB type cable. For example, the USB port may be a micro USB port and the USB type cable can have at least one micro USB type connector.

In some exemplary embodiments, the power adaptor may include a removable cable.

In exemplary embodiments, a pair of headphones may include a left speaker unit including a left speaker for providing audio output; a right speaker unit including a right speaker for providing audio output; an adjustable band configured to hold the left speaker unit and the right speaker unit; a first port located on one of the speaker units, the first port electrically connected to an internal power source of the headphones; a second port located on one of the speaker units, the second port electrically connected to the internal power source of the headphones; and a power management component for regulating the internal power source of the headphones so that when a first cable is connected to the first port and to an external device electrical power is transferred to the external device, and when a power adaptor is connected to the second port and to a wall outlet, the internal power source is being charged.

In some exemplary embodiments, one of the ports may be a USB port and the other port may be a micro USB port.

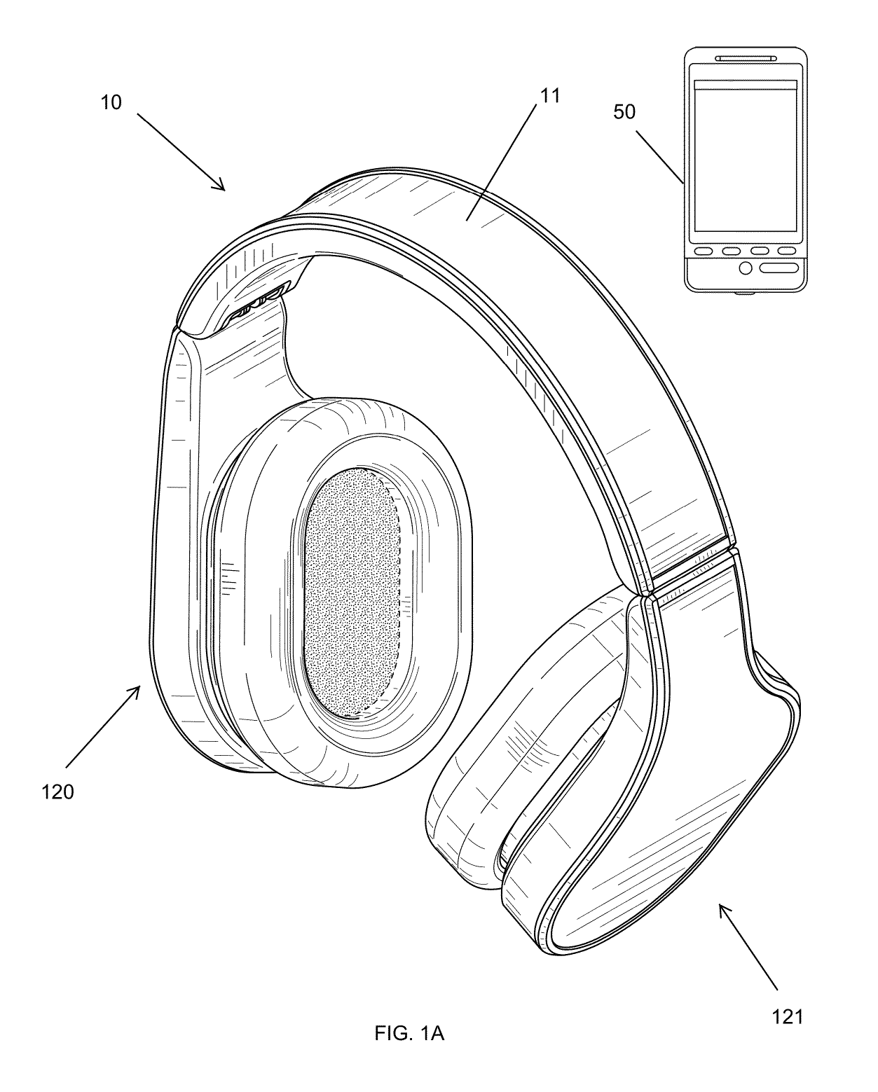

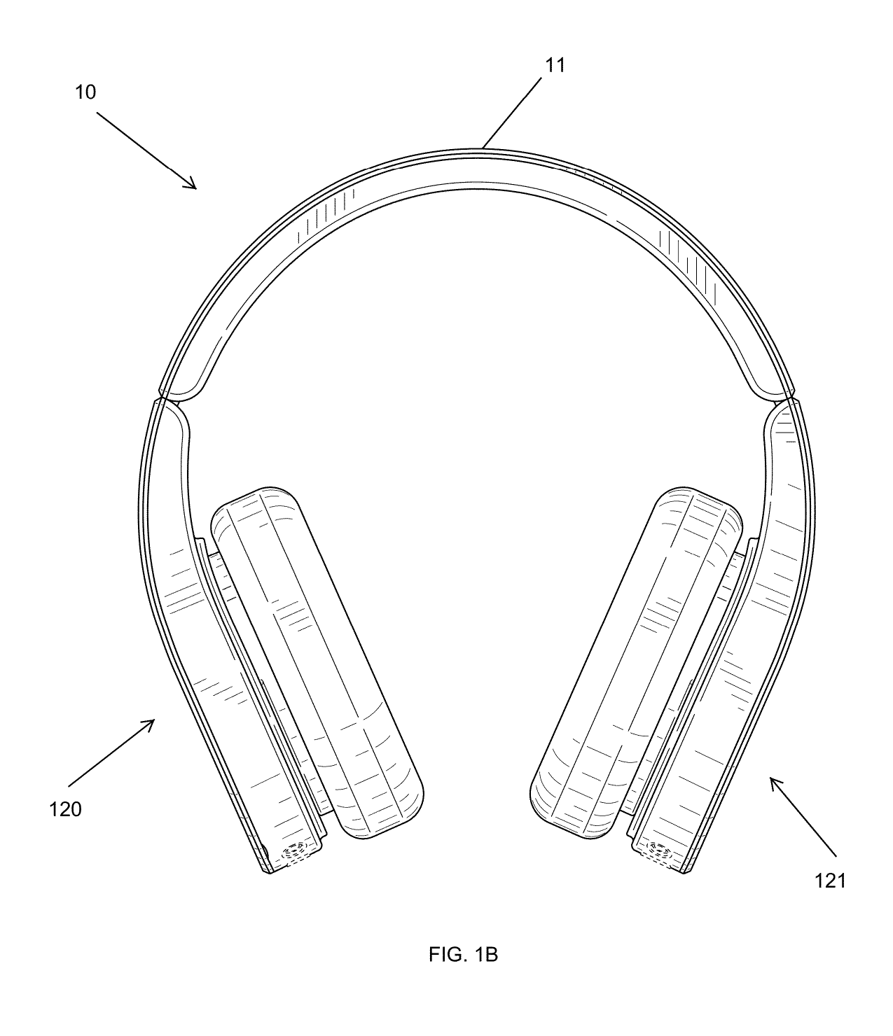

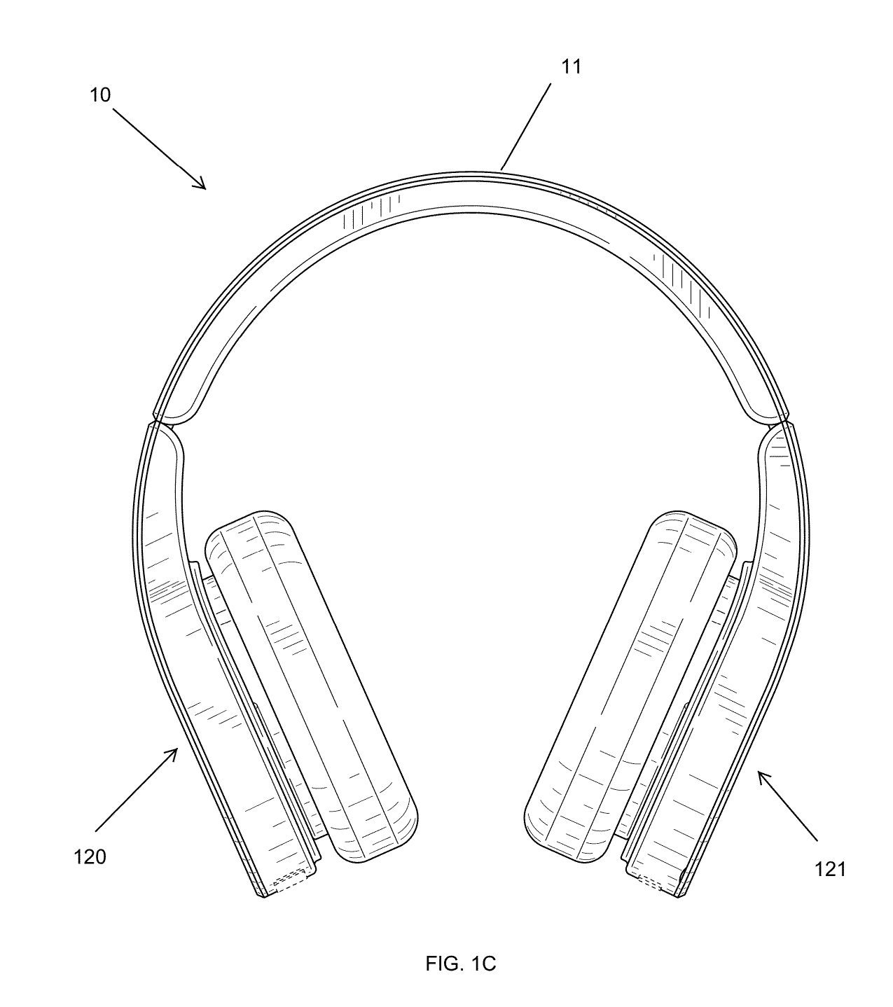

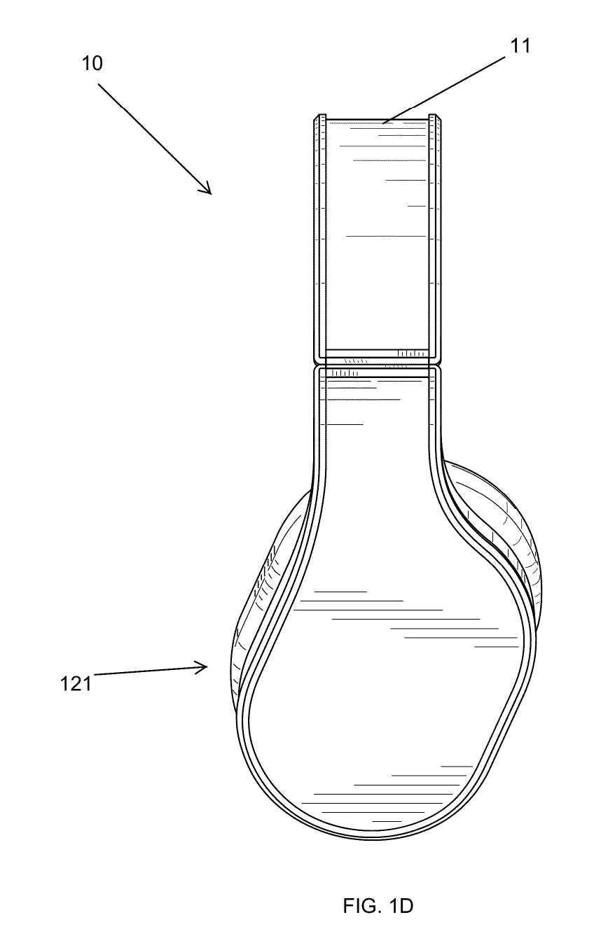

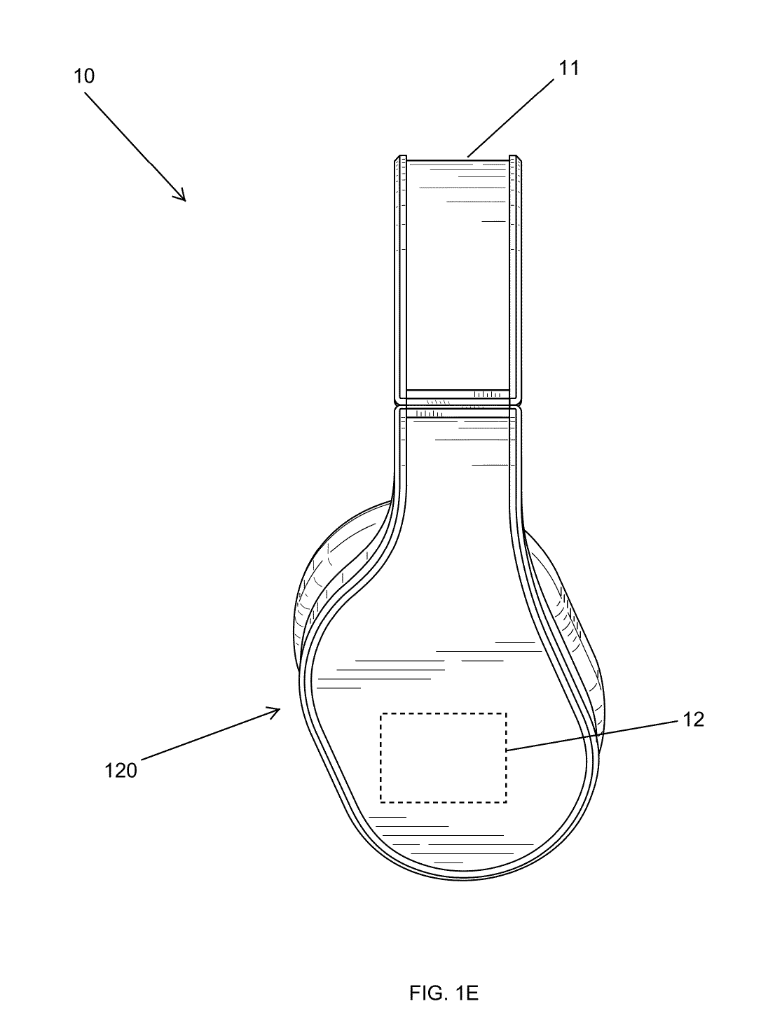

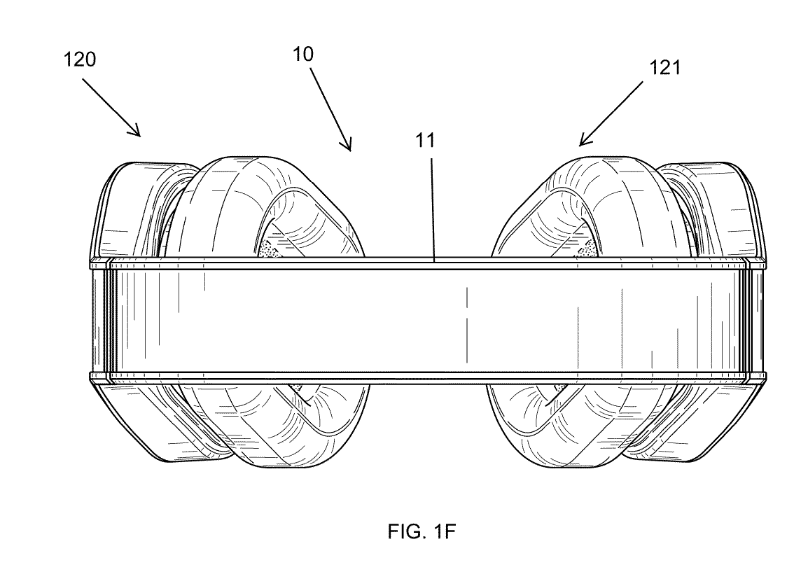

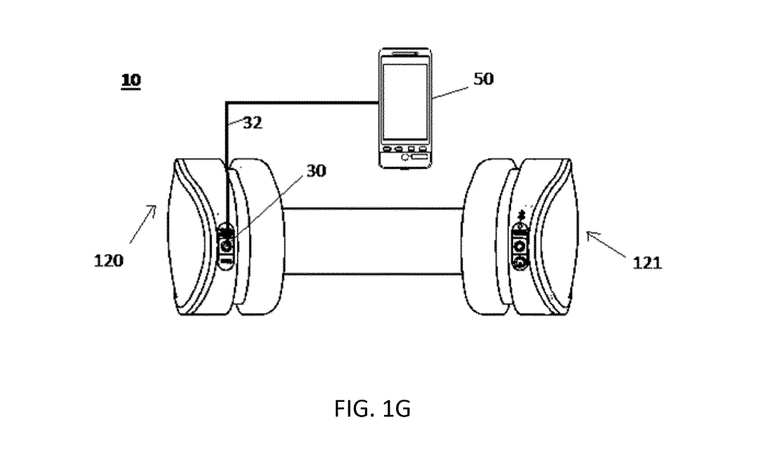

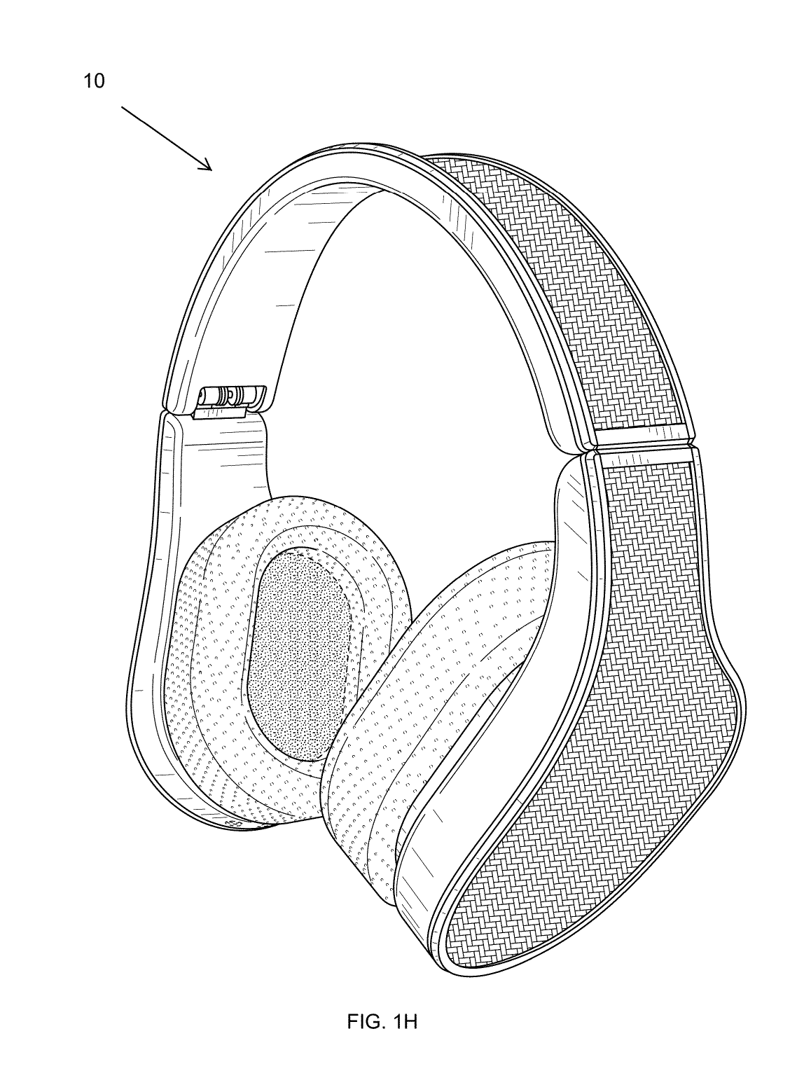

Referring to FIGS. 1A-1G, a pair of headphones 10 are shown according to an exemplary embodiment of the present invention. Headphones 10 are adapted for connection to an external device 50, as described further below.

Headphones 10, as shown, include a first speaker 120 and a second speaker 121 attached with a band 11. Each of the speakers 120 and 121 are configured to provide audio output, e.g., audible sounds, to a user of the headphones 10. Typically, a user wears the pair of headphones 10 about a portion of his or her head, for example, with the band overlying a top and/or back portion of his or her head so that each of the speakers 120 and 121 rests on or near a respective ear of the user.

Accordingly, the pair of headphones 10 may include a variety of configurations to facilitate the comfort or accessibility for a user, for example, padded and/or ergonomically curved sections. In embodiments, the band 11 may be adjustable, e.g., through a sliding or interlocking mechanism, so that the relative spacing of speakers 120 and 121 can be adjusted to accommodate users having differently-sized body portions.

Headphones 10 may incorporate a number of features to facilitate the transmission of data and/or electrical power throughout headphones 10 and/or external device 50. Accordingly, headphones 10 may include an internal power source 12 (shown best in FIG. 1D) for supplying electrical power for one or more functions of headphones 10 and/or external device 50. Headphones 10 may also include a port 30 (shown best in FIG. 1G) for facilitating the connection with the external device 50, for example, with an electrical cable 32.

Turning momentarily to FIG. 1H, an alternative embodiment of headphones 10 is illustrated. It will be understood that headphones 10 may have a variety of configurations in accordance with their intended use. For example, headphones 10 may incorporate internal or exterior features such as moisture-resistant materials or scratch-resistant materials.

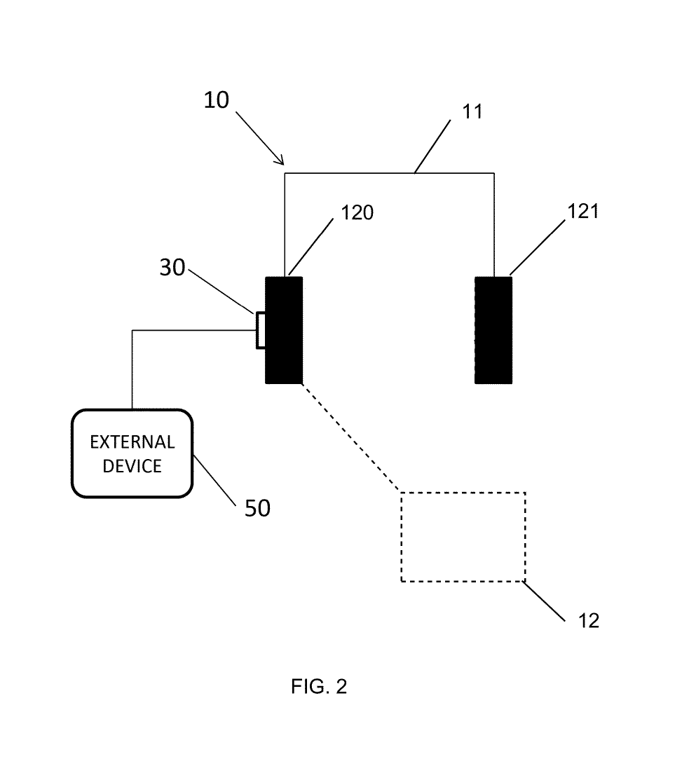

Referring to FIG. 2 a schematic diagram of the pair of headphones 10 connected to external device 50 is shown according to an exemplary embodiment of the present invention. Internal power source 12 is disposed in an interior portion of headphones 10 for powering on-board features or functionalities of the headphones 10 in addition to or alternative to powering an externally-connected device. The internal power source 12 can be one or more batteries, which can be disposable or rechargeable, for example, lithium ion (Li-ion) or nickel cadmium (NiCad)-type power cells or disposable alkaline batteries. In embodiments, the headphones 10 may also include other powered features or functionalities, including, for example, amplifiers, a Bluetooth transmitter and/or receiver, noise cancellation circuitry, and/or a power management device, to name a few. The headphones 10, are illustrated as being full size, e.g., banded, over-the-ear-type headphones with a pair of speaker units, but any other electrically powered headphone device including at least one speaker unit adapted to be worn on a head portion of a user may be used herein, for example, earbud-type or wraparound-type headphones.

With continued reference to FIG. 2, the headphones 10 connect to an external device 50 via communication port 30 in accordance with exemplary embodiments. The external device may be any device, for example mobile phones, smartphones (e.g., iPhone®, Android® devices, Blackberry® devices, Windows, etc.), tablets devices (e.g., iPad®, iPad® Mini, Android® tablet, Surface™, Chromebook, etc.), laptops, desktops, portable music players (e.g., iPod, iPodTouch, etc.), to name a few. It will be understood that other suitable types of external electronic devices can be used with the headphones described herein.

In embodiments, the headphones 10 can communicate data, and/or exchange electrical power via the port 30. As shown, the port 30 is integrated with one of speakers 120a, 120b. In embodiments, the port 30 can be located in any suitable location on a pair of headphones.

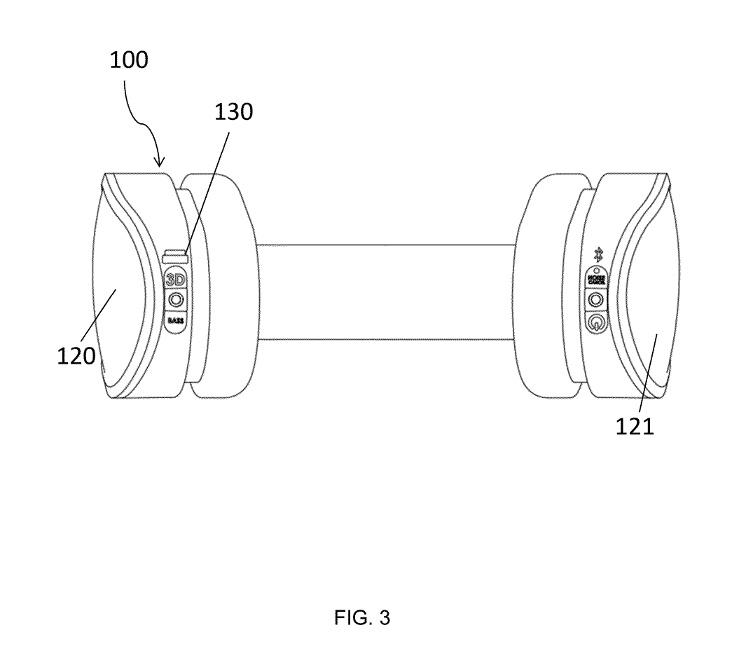

FIG. 3 illustrates, according to an exemplary embodiment, a pair of headphones 100 include a micro USB port 130 which can be used to charge the headphones (using a standard charge cable) and to charge other external devices. In this regard, the port 130 is integrated in one of the speakers 120. In embodiments, the port 130 can be electrically directly or indirectly connected to an internal power source of headphones 100. In exemplary embodiments, other ports can be used in lieu of a micro USB port or other USB port as discussed herein.

In exemplary embodiments, the flow of electrical power from the headphones 100 to an external device is facilitated or accomplished through the use of a specialized or modified cable. FIG. 3, shows, according to an exemplary embodiment, a modified USB cable 200. The cable 200 has a connector 210 for connecting to the headphones and an external connector 220 for connecting to an external device. In some embodiments, the connectors 210, 220 may be a micro USB type connector (because the headphones have a micro USB port), but cables with other types of connectors may be used in accordance with the embodiments described herein. In embodiments, the cable 200 may be modified such that at least one data pin of the connector is grounded or shorted. Other modifications can be made to the cable to enable a power management component (as discussed below) to distinguish between a charging cable and a discharging cable. The connection of cable to the headphones and to an external device causes electrical power to be transferred from the headphones to the electrical device.

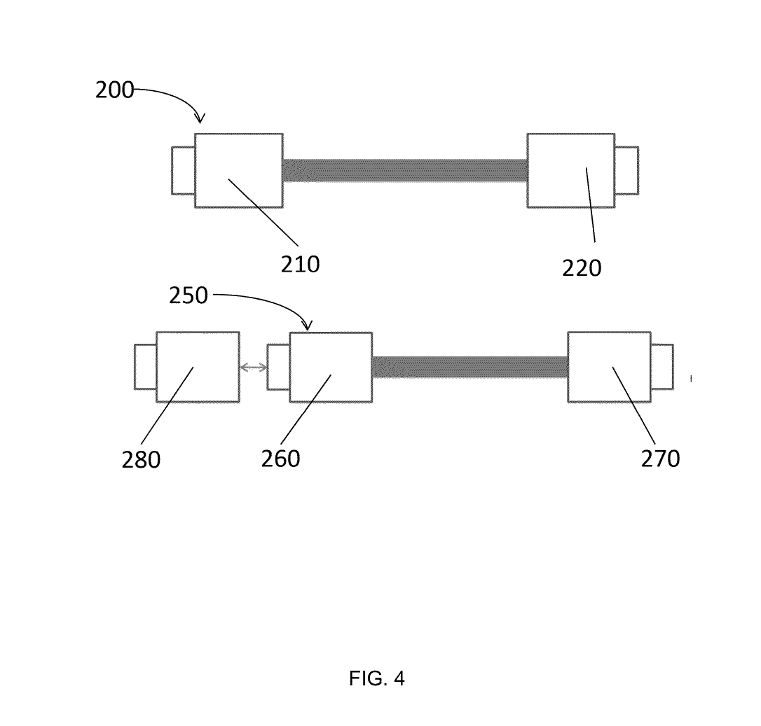

In some exemplary embodiments, instead of using a modified USB cable to facilitate the transfer of power to an external device, a regular cable, (e.g., a standard USB type cable and the like) with an adaptor can be used. For example, referring to FIG. 4, a standard USB type cable 250 with regular male USB connectors 260, 270 may connect to the headphones via the adaptor 280. For example, the adaptor 280 has a male USB connector and can receive or attach to another male USB connector, such as connector 260.

In embodiments, the wires or connectors of the adaptor 280 can be modified or wired in order to effectively ground or short the data pin of the cable 250, in order to cause the headphones to provide electrical power to the USB device. Thus, in order to transfer power from the headphones, the adaptor 280 can be arranged to connect to the USB port 130 of the headphones at one end and connect to one of the connectors 260, 270 of the cable 250 at the other end. The connector of the cable not attached to the adaptor 280 connects to the external device. Other modifications can be made to the adaptor to enable the power management component (as discussed below) to distinguish between a charging operation and a discharging operation.

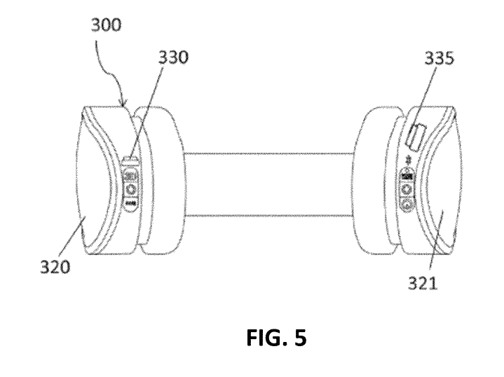

In exemplary embodiments, in order facilitate power from headphones to an external device, the headphones may include a modified port. For example, referring to FIG. 5, the headphones 300 have a micro USB port 330 built into speaker 320 and a regular USB port 335 built into speaker 321. The ports 330, 335 do not necessarily have to be incorporated on separate speaker units, such as speakers 320 and 321. Further, at least one of the ports 330, 335 can be modified so as to effectively modify a data pin of a connecting cable. Other modifications can be made to the ports to enable a power management component (as discussed below) to distinguish between a charging port and a discharging port. Therefore when a cable connects to the modified port and to an external device, electrical power transfers from the headphones to the external device. The unmodified port can be used in accordance with other functions of the headphones, e.g., to charge the headphones, update firmware, etc.

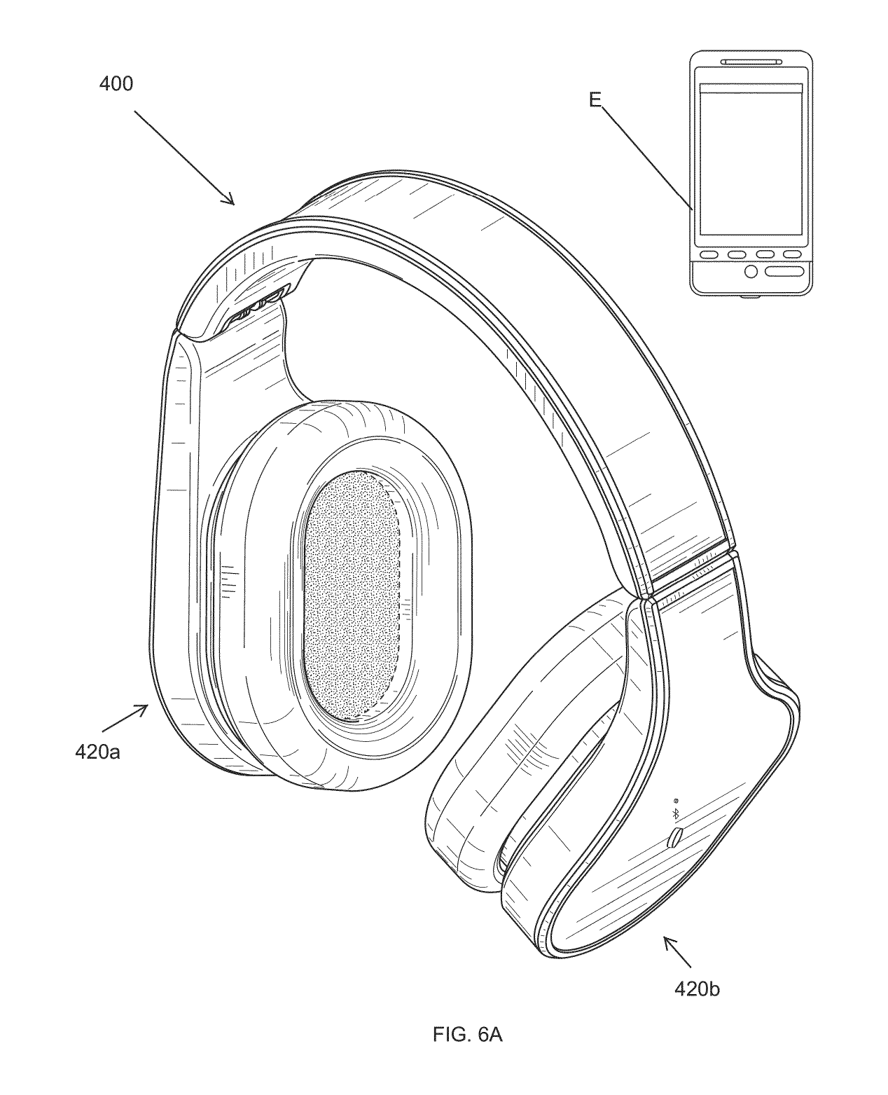

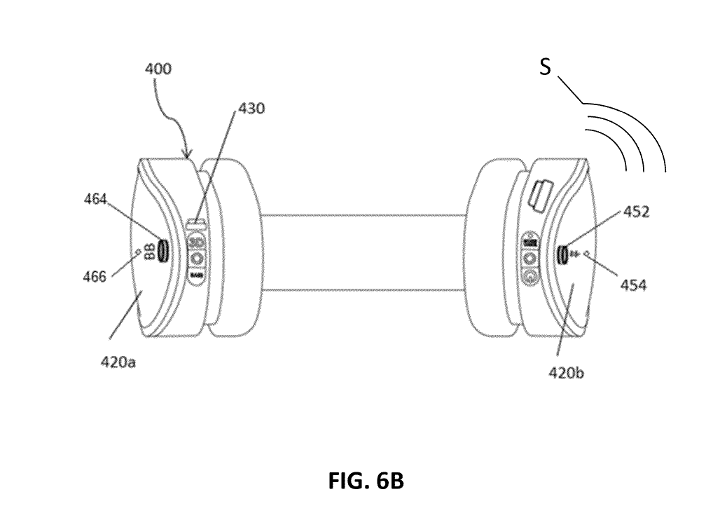

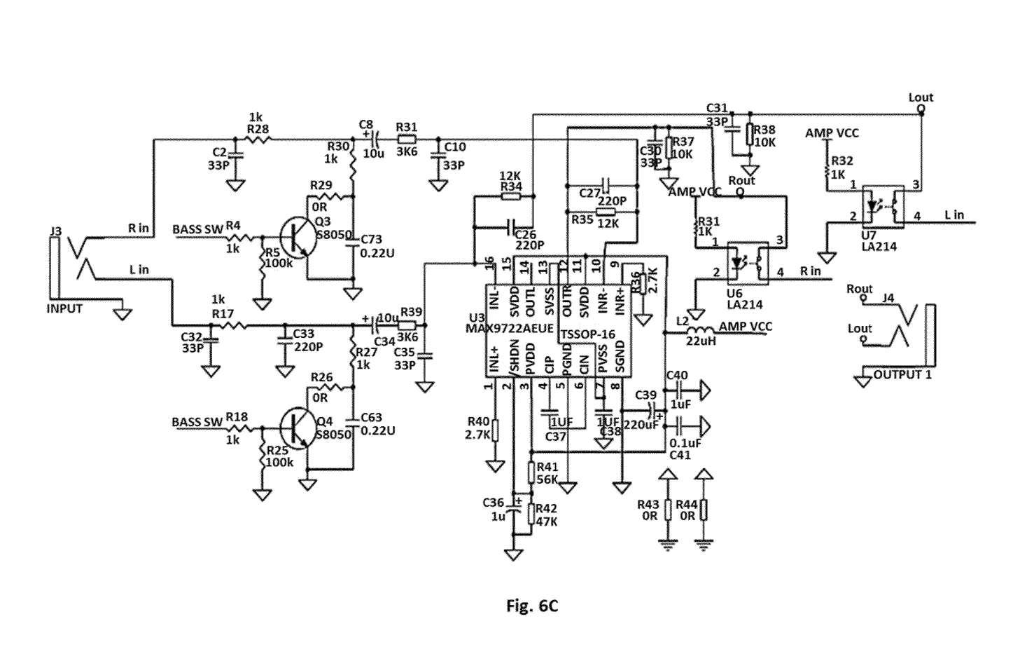

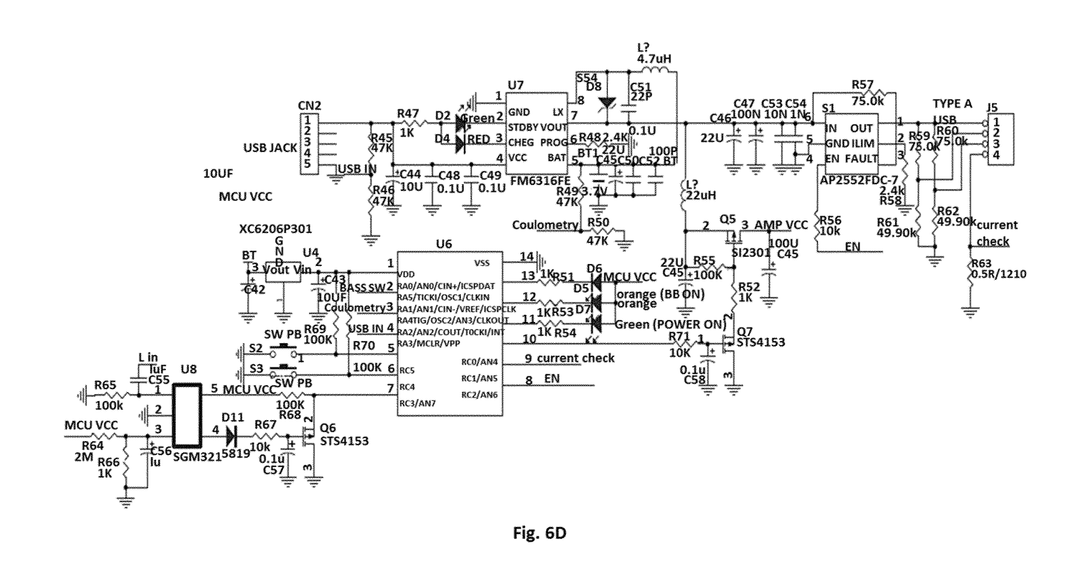

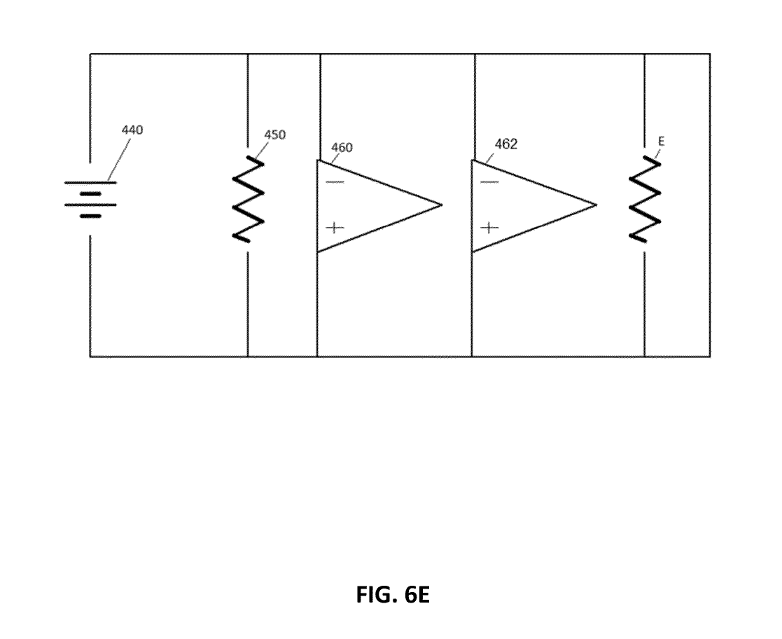

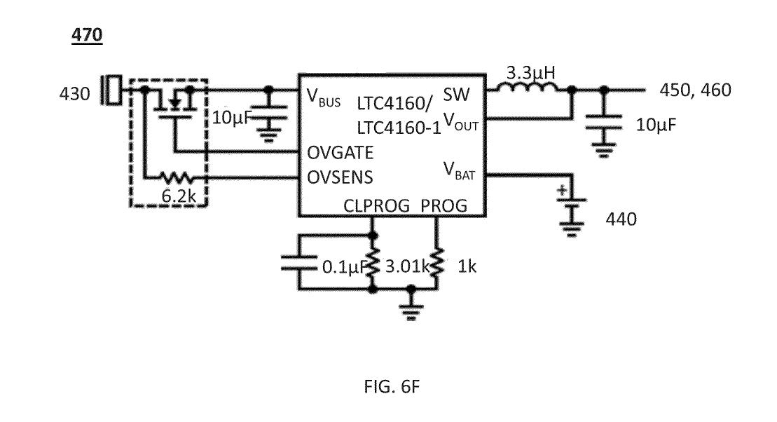

Turning to FIGS. 6A and 6B, a pair of headphones 400 may be provided that includes similar components to headphones 10, 100, 200, and/or 300 described above.

Accordingly, headphones 400 include a micro USB port 430 which can be used to charge an internal power source 440, such as a battery, in addition to transferring electrical signals, such as data signals, between headphones 400 and an external device E. In embodiments, internal power source 440 may be selectively electronically coupled or uncoupled from the remainder of electrically-powered components of headphones 400 described herein, e.g., through an electrical switch having an actuator such as a knob, button, dial, or toggle, to name a few. In embodiments, internal power source 440 may be selectively electronically coupled or uncoupled in this fashion through another type of actuator, such as a remote (e.g., infrared), radio signal (e.g., Bluetooth control), or voice- or motion-sensed activation.

In embodiments, internal power source 440 may be configured to enter a low power output mode, e.g., a standby mode or sleep mode, in which internal power source 440 outputs an amount of electrical energy sufficient for minimal functionality of electrically-powered components of headphones 400. In embodiments, a low power mode of internal power source 440 may be associated with, for example, a 0.2 mA electrical current output. In embodiments, a low power output mode associated with headphones 400 may be associated with a different electrical current output.

In embodiments, internal power source 440 may be lithium-ion (Li-ion) battery rated at 1200 mA-h. As described herein, internal power source 440 may be regulated such that a portion of the available electrical power available from internal power source 440 may be apportioned for different electrically-powered functions of headphones 400. In embodiments, internal power source 440 may have a different configuration, for example, a nickel-cadmium (NiCd) battery, a nickel-zinc (NiZn) battery, a nickel-metal hydride (Ni-MH) battery, a carbon-zinc battery, or an alkaline battery, to name a few, any of which may be rated at different electrical power outputs, for example, 800 mA-h, 900 mA-h, 1000 mA-h, 1100 mA-h, 1150 mA-h, 1200 mA-h, 1300 mA-h, or 1400 mA-h, to name a few.

In embodiments, headphones 400 may include one or more ports for data and/or charging operations, such a regular USB port 335 (FIG. 5) as described above, in any combination and/or arrangement. Such ports may be optionally provided on one or both of a pair of speakers 420a, 420b of headphones 400, or may be provided on other suitable locations of headphones 400. In embodiments, a dedicated port may be provided to receive analog audio signals from the connected external device E, or this functionality may be incorporated into another port, for example, micro USB port 430.

Still referring to FIGS. 6A and 6B, headphones 400 include one or more on-board electrically-powered components that can be supplied with electrical power from internal power source 440. As described herein, on-board electrically powered components of headphones 400 may be selectively activated (e.g., turned on and off by a user) or may be configured for continuous operation during use of headphones 400 or during a low power mode (e.g., a sleep mode or standby mode) of headphones 400.

In embodiments, headphones 400 may incorporate a wireless communication receiver 450. Wireless communication receiver 450 may be provided as an integrated wireless communication transceiver that includes a transmitter, receiver, and/or antenna into a single component. Wireless communication receiver 450 is configured to receive electromagnetic signals S that are transmitted wirelessly, for example, radio signals such as Bluetooth transmissions. In this regard, wireless communication receiver 450 may be electrically connected to one or both of speakers 420a and 420b of headphones 400 to convert a wirelessly received electromagnetic signal into audible sounds that can be enjoyed by a user. Such wirelessly received electromagnetic signals may be provided by a compatible wireless communication transmitter associated with external device E, or with another device within communications range of headphones 400.

Wireless receiver 450 may be selectively activated and/or deactivated by a user through a control 452 located on an external portion of headphones 400. Control 452 may be a knob, button, switch, toggle, or other type of actuator such as a remote (e.g., infrared), radio signal (e.g., Bluetooth control), or voice- or motion-sensed actuator that is operable to activate and/or deactivate wireless receiver 450. In embodiments, wireless receiver 450 may be configured for continuous operation during use of headphones 400 or during a low power mode (e.g., a sleep mode or standby mode) of headphones 400.

In embodiments, an indicator 454, such as an LED or other source of illumination, may be provided on headphones 400 to indicate the active and/or inactive status of wireless receiver 450.

Headphones 400 may additionally or alternatively include a wide spectrum amplifier 460 that can modulate an input audio signal having a first voltage into an output audio signal having a second, higher voltage, e.g., wide spectrum amplifier 460 may cause a voltage amplitude associated with an audio signal to increase by a factor or gain. The resultant increase in voltage of the audio signal provided to one or both of speakers 420a, 420b of headphones 400 facilitated by wide spectrum amplifier 460 can produce an audible sound that is louder, for example, at an audible level consistent with a 10 dB gain applied to the sound produced by an electrical signal without the wide spectrum amplifier 460. In embodiments, wide spectrum amplifier 460 may act upon an electrical signal along a range of frequencies, for example, between 20 Hz and 20,000 Hz. In embodiments, wide spectrum amplifier 460 may act upon an electrical signal along a different range of frequencies.

Accordingly, wide spectrum amplifier 460 may include an electrically-powered component, such as a transistor, that receives electrical power from the internal power source 440 to modulate an audio signal. In embodiments, wide spectrum amplifier 460 may be configured to continuously draw electrical power from the internal power source 440 during operation of headphones 400, e.g., wide spectrum amplifier 460 may be configured for activation upon electrical connection of internal power source 440 to one or more electrical circuits along which the remaining electrically-powered components of headphones 400 are disposed. In embodiments, wide spectrum amplifier 460 may draw electrical current during a low power output mode of internal power source 440 as described above at a rate of, for example, 0.2 mA.

Referring additionally to FIG. 6C, one possible electrical configuration of headphones 400 including wide spectrum amplifier 460 is shown according to an exemplary embodiment of the present invention. In embodiments, headphones 400 and/or wide spectrum amplifier 460 may have a different electrical configuration.

In embodiments, wide spectrum amplifier 460 may be selectively activated and/or deactivated by a user through a control located on an external portion of headphones 400. Control may be a dial, button, switch, toggle, or other type of actuator that is operable to activate and/or deactivate wide spectrum amplifier 460. In embodiments, an indicator, such as an LED or other source of illumination, may be provided on headphones 400 to indicate the active and/or inactive status of wide spectrum amplifier 460. In embodiments, wide spectrum amplifier 460 may be configured for voice activation, for example, through a microphone component and/or for remote activation, for example, through an infrared or Bluetooth signal.

Still referring to FIG. 6A and FIG. 6B, in embodiments, headphones 400 may additionally or alternatively include a low frequency amplifier 462. Low frequency amplifier 462 is configured to amplify an input electrical signal, e.g., an audio signal, having a first voltage into an output audio signal having a second, higher voltage, e.g., wide spectrum amplifier 460 may cause a voltage amplitude associated with an audio signal to increase by a factor or gain. Low frequency amplifier 462 may be configured to amplify an input electrical signal, e.g., an audio signal, along a selected range of frequencies, for example, between 20 Hz and 500 Hz. In embodiments, low frequency amplifier 462 may be configured to amplify the voltage of an input electrical signal along a different range of frequencies.

In embodiments, low frequency amplifier 462 may be configured to amplify an input electrical signal along a selected range of frequencies, and may be configured to have a minimal or negligible effect on frequencies outside, e.g., above or below, the selected range of frequencies. In embodiments, low frequency amplifier 462 may have a minimal or negligible effect, for example, on frequencies above 500 Hz.

In embodiments, low frequency amplifier 462 may be configured to attenuate, e.g., minimize or reduce, for example, through a fractional gain, an input electrical signal on frequencies above the selected range of frequencies. In such embodiments, the action of wide spectrum amplifier 460 described above may act to offset attenuation of an electrical signal in the frequency range above the selected frequency range upon which low frequency amplifier 462 acts. In this regard, headphones 400 may be configured such that low frequency amplifier 462 may only be activated in conjunction with wide spectrum amplifier 460, for example, so that low frequency amplifier 462 does not attenuate a range of frequencies below a desired level. In embodiments, wide spectrum amplifier 460 and low frequency amplifier 462 may be independently activated.

In embodiments, low frequency amplifier 462 may be selectively activated and/or deactivated by a user through a control 464 located on an external portion of headphones 400. Control 464 may be a dial, button, switch, toggle, or other type of actuator that is operable to activate and/or deactivate low frequency amplifier 462. In embodiments, an indicator 466, such as an LED or other source of illumination, may be provided on headphones 400 to indicate the active and/or inactive status of low frequency amplifier 462. In embodiments, low frequency amplifier 462 may be configured for voice activation, for example, through a microphone component and/or for remote activation, for example, through an infrared or Bluetooth signal.

Referring additionally to FIG. 6D, one possible electrical configuration of low frequency amplifier 462 is shown according to an exemplary embodiment of the present invention. In embodiments, low frequency amplifier 462 may have a different electrical configuration.

In embodiments, low frequency amplifier 462 may be selectively activated and/or deactivated by a user through a control 464 located on an external portion of headphones 400. Control 464 may be a button, switch, toggle, or other type of actuator that is operable to activate and/or deactivate amplifier. In embodiments, an indicator 466, such as an LED or other source of illumination, may be provided on headphones 400 to indicate the active and/or inactive status of low frequency amplifier 462. In embodiments, low frequency amplifier 462 may be configured for voice activation, for example, through a microphone component or for remote activation, for example, through and infrared or Bluetooth signal.

In this regard, the pair of headphones 400 described herein may be configured such that internal power source 440 can simultaneously provide electrical power for one or more powered functions native to headphones 400, e.g., wireless communication receiver 450, wide spectrum amplifier 460, and/or low frequency amplifier 462, as well as provide power to a connected external device E.

With specific reference to FIG. 6E, the wireless communication receiver 450, wide spectrum amplifier 460, low frequency amplifier 462, and external device E may be electrically connected in parallel with the internal power source 440 of headphones 400 so that one or more of wireless communication receiver 450, wide spectrum amplifier 460, and low frequency amplifier 462 can draw electrical power from the internal power source 440. As described above, at least wide spectrum amplifier 460 may be configured for continuous operation during use of headphones 400, e.g., wide spectrum amplifier 460 may be configured to continuously draw electrical power from internal power source 440 during use of headphones 400 or during a low power mode (e.g., a sleep mode or standby mode) of headphones 400. As shown, wireless communication receiver 450 is illustrated as an electrical resistor while wide spectrum amplifier 460 and low frequency amplifier 462 are illustrated as operational amplifiers.

Further, external device E is illustrated as a resistive element that can draw electrical power from internal power source 440 either independently of or simultaneously with wireless communication receiver 450 and/or wide spectrum amplifier 460 when external device E is connected to the headphones 400 via port 430 (FIG. 6B).

In exemplary embodiments, the headphones 10, 100, 200, 300, 400 described herein can further include a power management component for interfacing between the USB port used for transferring power and the internal power source of the headphones. In this regard the power management component may include an integrated circuit such as Linear Chip LTC4160. The Specification for the Linear Chip LTC4160 is available as a 2009 publication from Linear Technologies Corporation titled “LTC4160/LTC4160-1 Switching Power Manager with USB On-The-Go And Overvoltage Protection”) and is hereby incorporated by reference as if set forth herein.

Turning to FIG. 6F, an electrical circuit diagram of a one possible configuration of a power management component 470 is shown according to an exemplary embodiment of the present disclosure. As illustrated, the power management component 470 may include a voltage input V_{BUS} for connection to with the port 430, a voltage input V_{BAT} for receiving electrical power from the internal power source 440, and a voltage output V_{OUT} for supplying electrical power to one or more electrical loads, e.g., wireless communication receiver 450, wide spectrum amplifier 460, and/or low frequency amplifier 462. In embodiments, it will be understood that other configurations of power management component 470 with headphones 400 may be suitable.

In exemplary embodiments, power management component 470 may be used to safeguard the internal power source 440 of headphones 400 from being excessively drained. In other words, power management component 470 may prevent the transfer of electrical power once the power level of the internal power source 440 reaches or dips below a threshold value, for example (20% of the capacity of the internal power source 440). In exemplary embodiments, power management component 470 may apportion an amount of electrical power available from internal power source 440 as a reserve amount of electrical power for use with on-board electrically-powered functions of headphones 400 (e.g., wireless communication receiver 450, wide spectrum amplifier 460, and/or low frequency amplifier 462) that is not available for additional as an electrical power supply, for example, for external device E. In embodiments, power management component 470 may be configured to hold 200 mA-h of a 1200 mA-h capacity internal power source for powering one or more on-board electrically-powered function of headphones 400.

In some exemplary embodiments, power management component 470 may also control or regulate how fast electrical power is transferred from internal power source 440 of headphones 400. In embodiments, power management component 470 may be configured to control the flow of electrical energy from internal power source 440 to headphones 400 at a rate of, for example, 0.2 mA.

In some exemplary embodiments, the headphones may include an attached or affixed connector, such as a USB connector. In some embodiments, such a connector may be retractable. For example the cable/wire attached to such a USB connector may be capable of retracting into the interior of the headphones. In some exemplary embodiments, the connector (e.g., USB connector) may be attached headphones so as to be able to swivel. In this regard, the connector may swivel or conveniently fold next or into the headphones, or a portion thereof. Such connectors (e.g., retractable and/or swivel connectors) may be utilized, modified, and/or implemented in accordance with the embodiments described herein, e.g., in order to facilitate transferring power and/or data to and from the headphones.

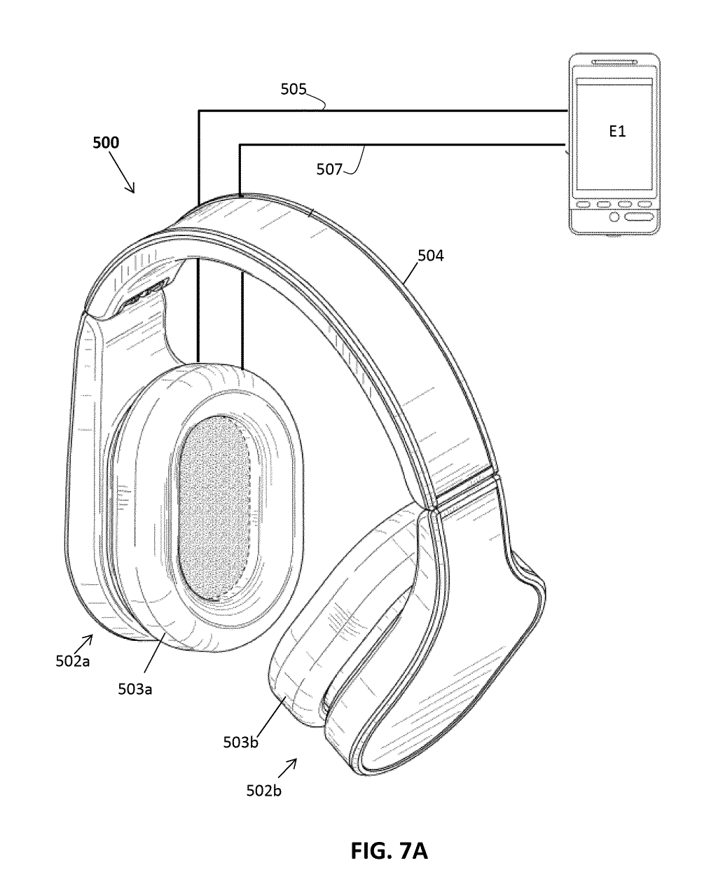

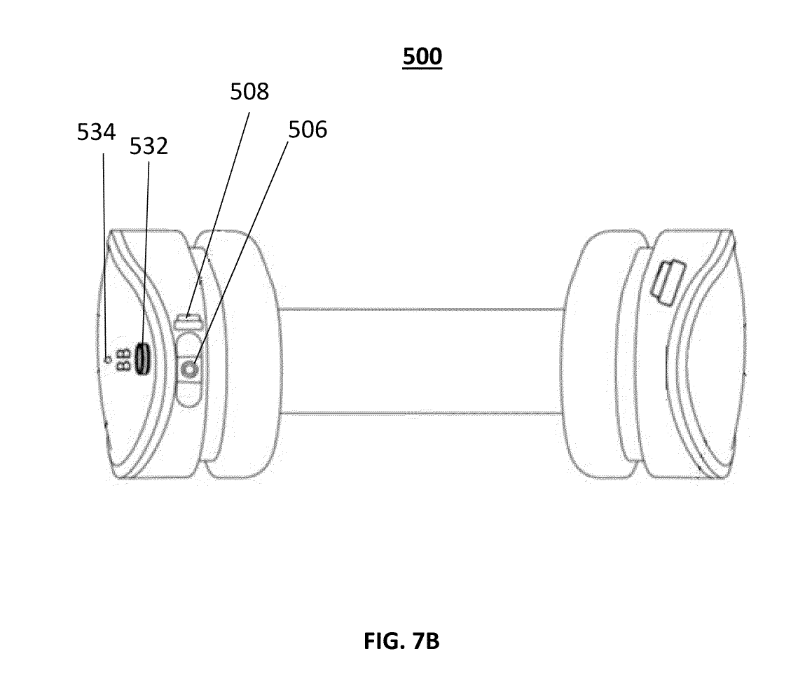

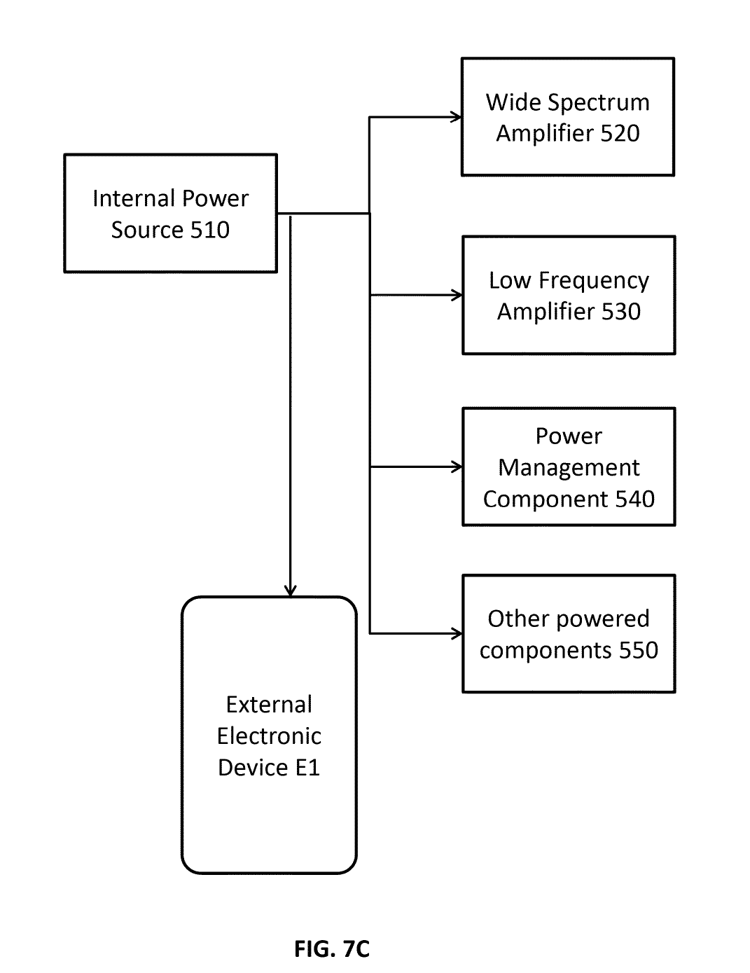

Turning now to FIG. 7A, a pair of headphones according to an exemplary embodiment of the present invention is generally designated 500. Headphones 500 may be electronically coupled with an external electronic device E1 via an audio signal cable 505 and a power transfer cable 507 so that electrical power may be transferred from headphones 500 to external electronic device E1, as described further herein.

Headphones 500 may include a first speaker unit 502a and a second speaker unit 502b interconnected with a band 504. Band 504 may be a rigid or flexible length of material such that first speaker unit 502a and second speaker unit 502b are joined, for example, to maintain a desired spacing between first speaker unit 502a and second speaker unit 502b, to prevent separation or loss of first speaker unit 502a and second speaker unit 502b, and/or to provide support for first speaker unit 502a and second speaker unit 502b by resting upon a portion of a user's body (e.g., atop a user's head or around a user's neck), to name a few. As shown, each of first speaker unit 502a and second speaker unit 502b may include a respective annular padding 503a, 503b for comfortable engagement with a portion of a user's head. In embodiments, first and second speaker units 502a, 502b having respective annular padding 503a, 503b may be configured to overlie at least a portion of a user's ears (e.g., an on-ear configuration) or may have a central recess sufficiently large to receive a portion of a user's ears therein (e.g., an over-the-ear configuration).

Each of first speaker unit 502a and second speaker unit 502b may be configured to receive an input electrical signal, e.g., an input audio signal and produce one or more audible sounds corresponding to the input electrical signal. Accordingly, first speaker unit 502a and second speaker unit 502b may transform an input audio signal into audible sounds that may be detected by a user in proximity to first speaker unit 502a and second speaker unit 502b, typically a user wearing headphones 500. Such input audio signals may be produced by external electronic device E1 located in proximity to headphones 500. In this regard, external electronic device E1 may be one or more electronic devices that are configured to electronically transmit audio media content, for example, mobile phones, smartphones, portable digital music players (such as an iPod), computers (such as desktop, laptop, or tablet-type computers), television sets and/or radios, to name a few. External electronic device E1 may include a respective internal power source EP (FIG. 7B) for providing electrical power to native functions of external electronic device E1.

Still referring to FIG. 7A, and referring additionally to FIG. 7B, headphones 500 are shown having an audio input port 506 for receiving audio signal cable 505. Audio input port 506 may be configured to receive, for example, a 3.5 mm audio jack fitted on the analog audio signal cable 504, with an opposite end of analog audio signal cable 505 electronically coupled with external device E1 so that analog audio signals may be transmitted from external electronic device E1 to headphones 500 via audio signal cable 505.

Headphones 500 additionally include a power transfer port 508 for receiving a portion of power transferring cable 507, for example, an adapter plug fitted on an end of power transferring cable 506. Power transfer port 508 is electronically coupled with an internal power source 510 (FIG. 7C) of headphones 500 so that electrical power may be transferred from headphones 500 to external electronic device E1, as described further herein. Accordingly, power transfer port 508 may have a configuration suitable to transfer electrical power therethrough, for example, a USB-A port, a mini USB-A port, a micro USB-A port, a USB-B port, a mini USB-B port, a micro USB-B port, or a Lightning Port, to name a few.

While audio input port 506 and power transfer port 508 are shown on the bottom of first and second speaker units 502a, 502b of headphones 500, respectively, it will be understood that audio input port 506 and power transfer port 508 may be arranged in a different fashion on headphones described herein.

Still referring to FIG. 7A and FIG. 7B, and referring additionally to FIG. 7C, a schematic diagram of various components of headphones 500 is illustrated.

Headphones 500 may include an internal power source 510 for providing electrical power to one or more native functions of headphones 500 and/or for providing electrical power to external electronic device E. Internal power source 510 may be, for example, a 3.7V lithium-ion (Li-ion) battery rated at 1200 mA-h. In embodiments, internal power source 510 may have a different configuration, for example, a nickel-cadmium (NiCad) battery, a nickel-zinc (NiZn) battery, a nickel-metal hydride (Ni-MH) battery, a carbon-zinc battery, or an alkaline battery, to name a few. Internal power source 510 may be interiorly-disposed within a portion of headphones 500, for example, in a battery compartment. In embodiments, internal power source 510 may have a different configuration, such as a 4.7V potential and/or may be rated for a different electrical power output, for example, 800 mA-h, 900 mA-h, 1000 mA-h, 1100 mA-h, 1150 mA-h, 1200 mA-h, 1300 mA-h, or 1400 mA-h, to name a few.

Still referring to FIG. 7A, FIG. 7B, and FIG. 7C, headphones 500 may include one or more on-board electrically-powered components that may be supplied with electrical power from internal power source 510. As described herein, on-board electrically powered components of headphones 500 may be selectively activated (e.g., turned on and off by a user) and/or may be configured for continuous operation during use of headphones 500 or during a low power mode (e.g., a sleep mode or standby mode) of headphones 500.

Headphones 500 may include a wide spectrum amplifier 520 that may modulate an input audio signal having a first voltage into an output audio signal having a second, higher voltage, e.g., wide spectrum amplifier 520 may cause a voltage amplitude associated with an input audio signal to increase by a factor or gain. The resultant increase in voltage of the input audio signal provided to one or both of speaker units 502a, 502b of headphones 500 facilitated by wide spectrum amplifier 520 may produce an audible sound that is louder, for example, at an audible level consistent with a 10 dB gain applied to the sound produced by an electrical signal without the wide spectrum amplifier 520. In embodiments, wide spectrum amplifier 520 may act upon an input electrical signal along a selected range of frequencies, for example, between 20 Hz and 20,000 Hz. In embodiments, wide spectrum amplifier 520 may act upon an electrical signal along a different range of frequencies.

Accordingly, wide spectrum amplifier 520 may include an electrically-powered component, such as a transistor, that receives electrical power from the internal power source 510 to modulate an input audio signal. In embodiments, wide spectrum amplifier 520 may be configured to continuously draw electrical power from the internal power source 510 during operation of headphones 500, e.g., wide spectrum amplifier 520 may be configured for activation upon electrical connection of internal power source 510 to one or more electrical circuits along which the remaining electrically-powered components of headphones 500 are disposed. In embodiments, wide spectrum amplifier 520 may draw electrical current during a low power output mode of internal power source 510 as described above at a rate of, for example, 0.2 mA.

In embodiments, wide spectrum amplifier 520 may be selectively activated and/or deactivated by a user through a control located on an external portion of headphones 500. Such a control may be a dial, button, switch, toggle, or other type of actuator that is operable to activate and/or deactivate wide spectrum amplifier 520. In embodiments, an indicator, such as an LED or other source of illumination, may be provided on headphones 500 to indicate the active and/or inactive status of wide spectrum amplifier 520. In embodiments, wide spectrum amplifier 520 may be configured for voice activation, for example, through a microphone component and/or for remote activation, for example, through an infrared or Bluetooth signal.

Still referring to FIG. 7A, FIG. 7B, and FIG. 7C, headphones 500 may include a low frequency amplifier 530. Low frequency amplifier 530 may be configured to amplify an input audio signal, having a first voltage into an output audio signal having a second, higher voltage, e.g., low frequency amplifier 530 may cause a voltage amplitude associated with an audio signal to increase by a factor or gain. Low frequency amplifier 530 may be configured to amplify an input audio signal along a selected range of frequencies, for example, between 20 Hz and 500 Hz. In embodiments, low frequency amplifier 530 may be configured to amplify the voltage of an input audio signal along a different range of frequencies.

In embodiments, low frequency amplifier 530 may be configured to amplify an input electrical signal along a selected range of frequencies, and may be configured to have a minimal or negligible effect on frequencies outside, e.g., above or below, the selected range of frequencies. In embodiments, low frequency amplifier 530 may have a minimal or negligible effect, for example, on frequencies above 500 Hz and/or below 20 Hz.

In embodiments, low frequency amplifier 530 may be configured to attenuate, e.g., minimize or reduce, for example, through a fractional gain, an input audio signal on frequencies above the selected range of frequencies. In such embodiments, the action of wide spectrum amplifier 520 described above may act to offset attenuation of an electrical signal in the frequency range above the selected frequency range upon which low frequency amplifier 530 acts. In this regard, headphones 500 may be configured such that low frequency amplifier 530 may only be activated in conjunction with wide spectrum amplifier 520, for example, so that low frequency amplifier 530 does not attenuate a range of frequencies below a desired level. In embodiments, wide spectrum amplifier 520 and low frequency amplifier 530 may be independently activated.

In embodiments, low frequency amplifier 530 may be selectively activated and/or deactivated by a user through a control 532 located on an external portion of headphones 500. Control 532 may be a dial, button, switch, toggle, or other type of actuator that is operable to activate and/or deactivate low frequency amplifier 530. In embodiments, an indicator 534, such as an LED or other source of illumination, may be provided on headphones 500 to indicate the active and/or inactive status of low frequency amplifier 530. In embodiments, low frequency amplifier 530 may be configured for voice activation, for example, through a microphone component and/or for remote activation, for example, through an infrared or Bluetooth signal.

Still referring to FIG. 7A, FIG. 7B, and FIG. 7C, headphones 500 may include a power management component 540 to control an amount of electrical power output from the internal power source 510 of headphones 500 to one or more electrically-powered components of headphones 500 and/or external electronic device E1. Power management component 540 may be a an Ethernet switch chip, for example, a Fulcrum Microsystems FocalPoint® FM6000 Series Ethernet switch chip (e.g., a part number FM6316 Ethernet switch chip), the specifications for which are available as a Product Brief titled “FocalPoint® FM6000 Series” published by Fulcrum Microsystems on Oct. 21, 2010, which is hereby incorporated by reference as if set forth herein. In embodiments, power management component 540 may have a different configuration.

Power management component 540 may be configured to apportion an amount of electrical power to be supplied by the internal power source 510 of headphones 500 to onboard electrically-powered components, e.g., wide spectrum amplifier 520 and low frequency amplifier 530, and/or external electronic device E1. For example, power management component 540 may be configured to supply 10% of the available electrical power from internal power supply 510 to wide spectrum amplifier 520 and low frequency amplifier 530, and to supply the remaining 90% of the available electrical power from internal power supply 510 to the external electronic device E1, e.g., to charge the internal power supply EP of external electronic device E1. In embodiments, power management component 540 may be configured to apportion different respective amounts of available electrical power from the internal power supply of headphones 500 to external electronic device E1, for example, 1%, 2%, 3%, 4%, 5%, 10%, 20%, 25%, 33%, 40%, 50%, 60%, 66%, 70%, 75%, 80%, or 100%, to name a few.

In embodiments, power management component 540 may be configured to control an amount of electrical power from internal power source 510 of headphones 500 to onboard electrically-powered components and/or external electronic device E1 based on a condition of one or more electronic devices that are electronically coupled to headphones 500, e.g., external electronic device E1. For example, power management component 540 may be configured to apportion an amount of electrical power from internal power source 510 to external electronic device E1 when it detects that an internal power source of external electronic device E1 has reached a threshold level, for example, 1%, 2%, 3%, 4%, 5%, 10%, 20%, 25%, 33%, 50%, 66% or 75%, to name a few. In this regard power management component 540 may be configured to monitor one or more conditions relating to external electronic device E1 and act to apportion an amount of electrical power to external electronic device E1 in response. In this regard, headphones 500 may be provided with power management component 540 such that the internal power supply 510 of headphones 500 may supply electrical power to external electronic device E1 connected via power transfer cable 507, e.g., in a charging operation, and may simultaneously supply electrical power to native electrically-powered components of headphones 500 (e.g., wide spectrum amplifier 520, low frequency amplifier 530, and/or other electrically-powered components 550). In embodiments, internal power supply 510 may supply electrical power to native electrically-powered components of headphones 500 and not to external electronic device E1. In embodiments, internal power supply 510 may supply electrical power to external electronic device E1 and not to native electrically-powered components of headphones 500.

In embodiments, power management component 540 may be configured to control an amount of electrical power from internal power source 510 of headphones 500 to onboard electrically-powered components and/or external electronic device E1 based on a condition of one or more electronic devices that are electronically coupled to headphones 500, e.g., external electronic device E1, in addition to the condition of the internal power source 510 of headphones 500. For example, power management component 540 may be configured to apportion an amount of electrical power from internal power source 510 to external electronic device E1 when it detects that an internal power source of external electronic device E1 is at or below a threshold level, for example, 1%, 2%, 3%, 4%, 5%, 10%, 20%, 25%, 33%, 50%, 66% or 75%, to name a few, and power management component 540 may also be configured to alter, e.g., halt, delay, decrease, or increase, such a charging operation based upon a condition of internal power source 510. For example, when power management component 540 detects that an internal power source of external electronic device E1 is at or below a threshold level such that additional electrical power is needed, power management component 540 may be configured to apportion a lesser amount of electrical power, e.g., a fractional amount of electrical power or no electrical power, to external electronic device E1 in the event that internal power source 510 of headphones 500 is at or below a threshold level, for example, 1%, 2%, 3%, 4%, 5%, 10%, 20%, 25%, 33%, 50%, 66% or 75%, to name a few In this regard power management component 540 may be configured to monitor one or more conditions relating to external electronic device E1 as well as the internal power source 510 of headphones 500 and act to apportion an amount of electrical power to external electronic device E1 in response. In this regard, power management component 540 may be configured to delay, halt, increase, or decrease an amount of electrical power to be transferred from the internal power source 510 of hedaphones 500 to external electronic device E1 such that the internal power source 510 of headphones 500 maintains a desired level, e.g., a set value or range, of electrical power, such that an internal power source of external electronic device E1 maintains a desired level of electrical power, or both. In embodiments, power management component 540 may be configured to maintain a ratio of electrical power stored in the internal power source 510 of headphones 500 as compared to an internal power source of external electronic device E1, for example, a 1:1 ratio, a 1:2 ratio, 1:3 ratio, a 1:4 ratio, a 1:5 ratio, a 1:10 ratio, a 10:1 ratio, a 5:1 ratio, a 4:1 ratio, a 3:1 ratio, or a 2:1 ratio, to name a few.

In embodiments, power management component 540 may prevent the transfer of electrical power to external device E1 once the power level of the internal power source 510 of headphones 500 reaches or dips below a threshold value, for example, 1%, 2%, 3%, 4%, 5%, 10%, 15%, or 20% of the capacity of the internal power source 510 of headphones 500, to name a few.

In embodiments, power management component 540 may be configured to regulate the rate at which electrical power is transferred from internal power source 510 of headphones 500. In embodiments, power management component 540 may be configured to control the flow of electrical energy from internal power source 510 to headphones 500 at a rate of, for example, 0.2 mA.

In this regard, headphones 500 may be provided with power management component 540 such that the internal power supply 510 of headphones 500 may supply electrical power to external electronic device E1 connected via power transfer cable 507, e.g., in a charging operation, and may simultaneously supply electrical power to native electrically-powered components of headphones 500 (e.g., wide spectrum amplifier 520, low frequency amplifier 530, and/or other electrically-powered components 550). In embodiments, internal power supply 510 may supply electrical power to native electrically-powered components of headphones 500 and not to external electronic device E1. In embodiments, internal power supply 510 may supply electrical power to external electronic device E1 and not to native electrically-powered components of headphones 500.

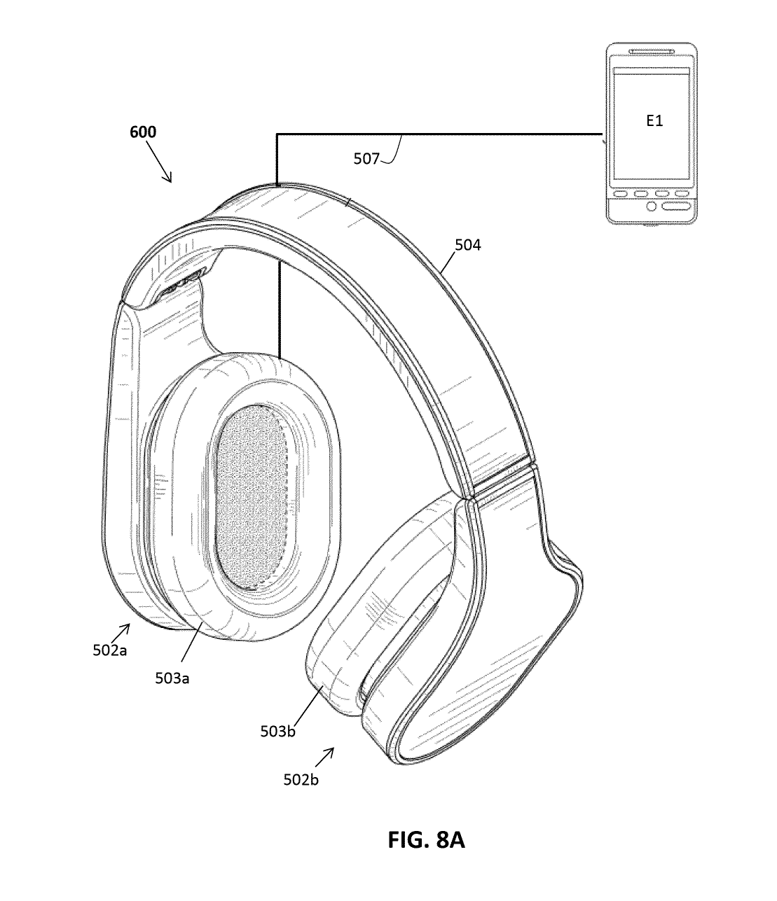

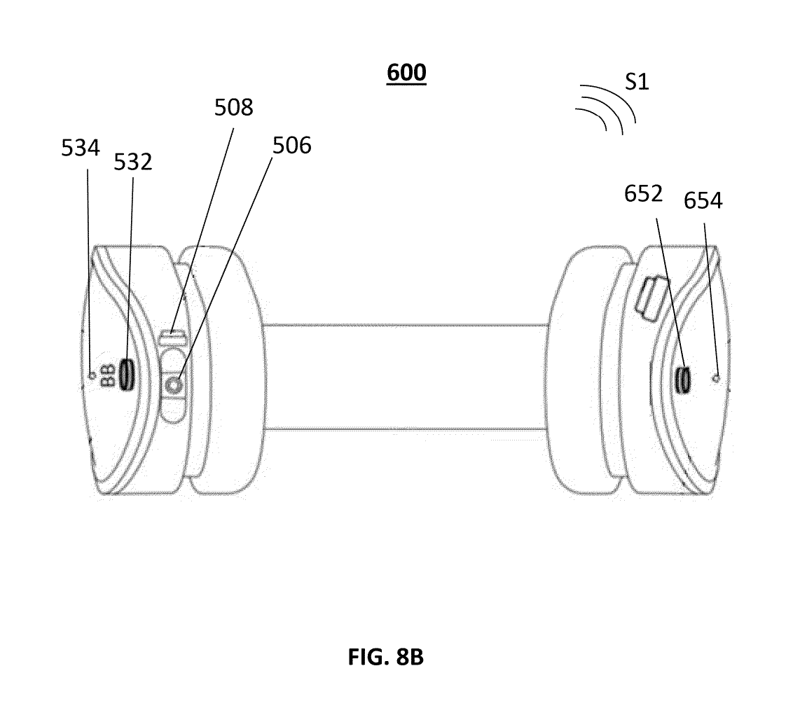

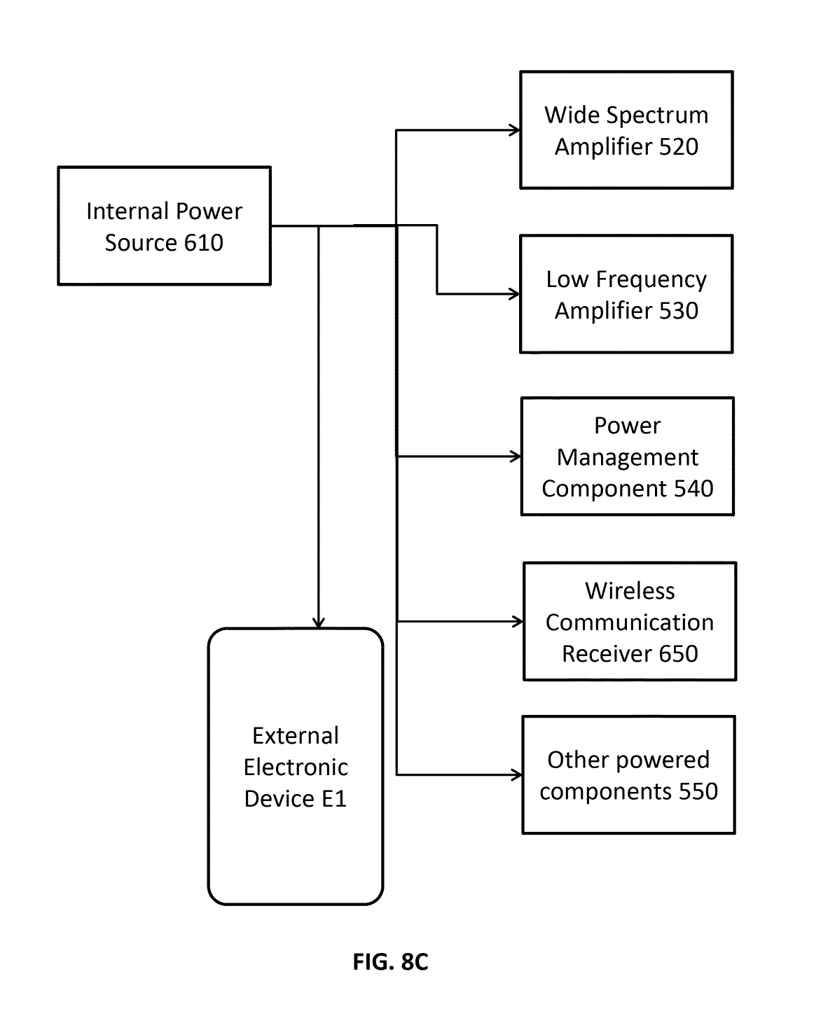

Turning now to FIG. 8A, a pair of headphones according to an exemplary embodiment of the present invention is generally designated 600. Headphones 600 may include substantially similar components to headphones 500 described above, such as first speaker unit 502a having annular padding 503a and second speaker unit 502b having annular padding 503b and interconnected with band 504. As shown, headphones 600 may be electronically coupled with external device E1 via power transferring cable 507 so that electrical power may be transferred from headphones 600 to external electronic device E1, as described further herein.

Still referring to FIG. 8A, and referring additionally to FIG. 8B, headphones 600 may include power port 508 for receiving an adapter portion of power transferring cable 507. As shown, headphones 600 may also include audio input port 506 for receiving a portion of an audio signal cable.

Still referring to FIG. 8A and FIG. 8B, and referring additionally to FIG. 8C, a schematic diagram of headphones 600 is shown. Headphones 600 may include wide spectrum amplifier 520, low frequency amplifier 530, and power management component 540 as described above. Headphones 600 may also include an internal power source 610 for providing electrical power to various components of headphones 600. Internal power source 610 may have a similar configuration to internal power source 510 described above, but may be configured to accommodate additional on-board electrically-powered components, as described further herein. For example, internal power source 610 may be a 3.7V, 1400 m-Ah Li-ion battery.

Headphones 600 also include a wireless communication receiver 650 for receiving wireless communications, e.g., an audio signal transmitted by external electronic device E1. Wireless communication receiver 650 may be provided as an integrated wireless communication transceiver that includes a transmitter, receiver, and/or antenna into a single component. Wireless communication receiver 650 may be configured to receive electromagnetic signals S1 that are transmitted wirelessly, for example, radio signals such as Bluetooth transmissions. In this regard, wireless communication receiver 650 may be electrically connected to one or both of speaker units 502a and 502b of headphones 600 to convert a wirelessly received electromagnetic signal into audible sounds that may be enjoyed by a user. Such wirelessly received electromagnetic signals may be provided by a compatible wireless communication transmitter associated with external device E1, or with another device within communications range of headphones 600.

As shown, wireless communication receiver 650 may be directly electronically coupled with wide range amplifier 520 such that loss of quality of an audio signal transmitted through wireless communication receiver 650 is minimized, e.g., made to be negligible or zero.

Wireless communication receiver 650 may be selectively activated and/or deactivated by a user through a control 652 located on an external portion of headphones 600. Control 652 may be a knob, button, switch, toggle, or other type of actuator such as a remote (e.g., infrared), radio signal (e.g., Bluetooth control), or voice- or motion-sensed actuator that is operable to activate and/or deactivate wireless communication receiver 650. In embodiments, wireless communication receiver 650 may be configured for continuous operation during use of headphones 600 or during a low power mode (e.g., a sleep mode or standby mode) of headphones 600. An indicator 654, such as an LED or other source of illumination, may be provided on headphones 600 to indicate the active and/or inactive status of wireless communication receiver 650.

In this regard, it will be understood that headphones 600 may be configured to receive input audio signals from external electronic device E1 or other sources without the need for a separate cable for transmitting an audio input signal to headphones 600. Accordingly, a user may listen to audio produced by headphones 600 while providing electrical power to external electronic device E1 through power transferring cable 507, and without the need for an audio input cable. Audio input port 506 may also be provided so that a user may optionally connect external device E1 to headphones 600 via an audio signal cable to transfer an input audio signal. In embodiments, audio input port 506 may be absent from headphones 600, for example, to reduce manufacturing costs.

Headphones 600 may be provided with power management component 540 such that the internal power supply 610 of headphones 600 may supply electrical power to external electronic device E1 connected via power transfer cable 507, e.g., in a charging operation, and may simultaneously supply electrical power to native electrically-powered components of headphones 600 (e.g., power management component 540, wide spectrum amplifier 520, low frequency amplifier 530, wireless communication receiver 650, and/or other electrically-powered components 550). In embodiments, internal power supply 610 may supply electrical power to native electrically-powered components of headphones 600 and not to external electronic device E1. In embodiments, internal power supply 610 may supply electrical power to external electronic device E1 and not to native electrically-powered components of headphones 600.

Power management component 540 may be configured to monitor one or more conditions relating to external electronic device E1 and act to apportion an amount of electrical power to external electronic device E1 in response, as described above with respect to headphones 500.

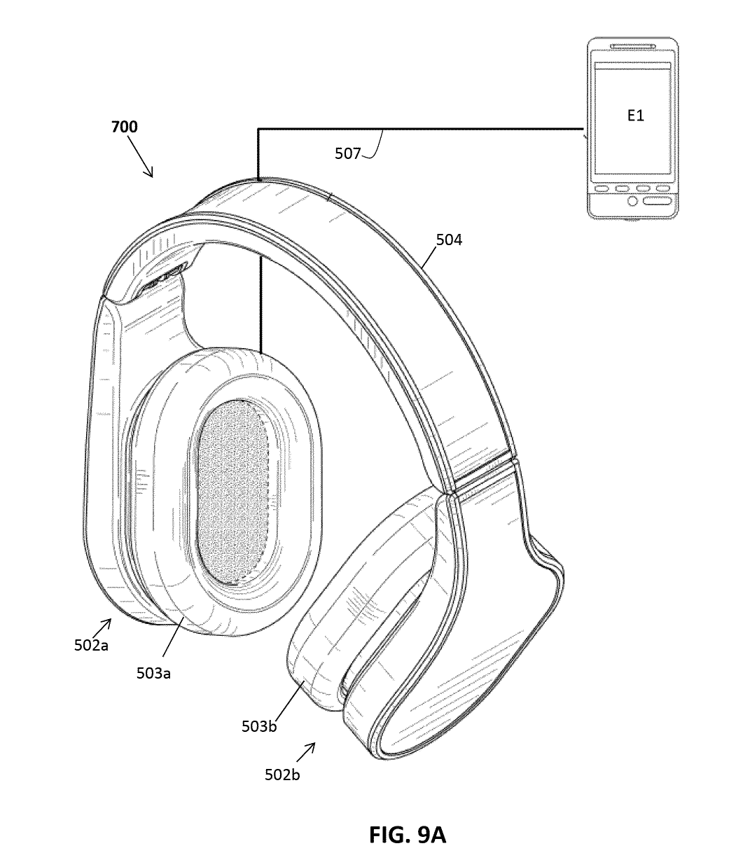

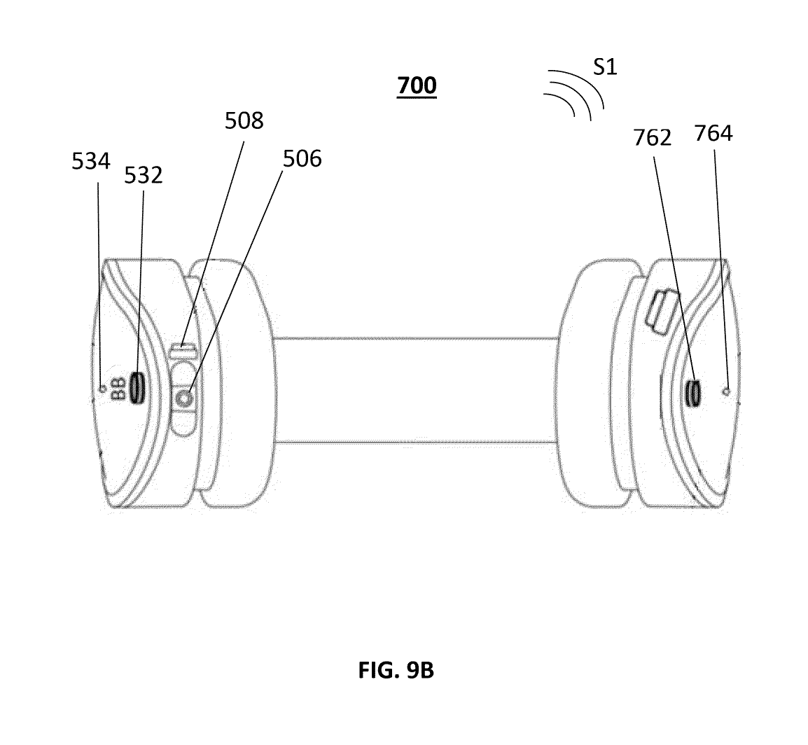

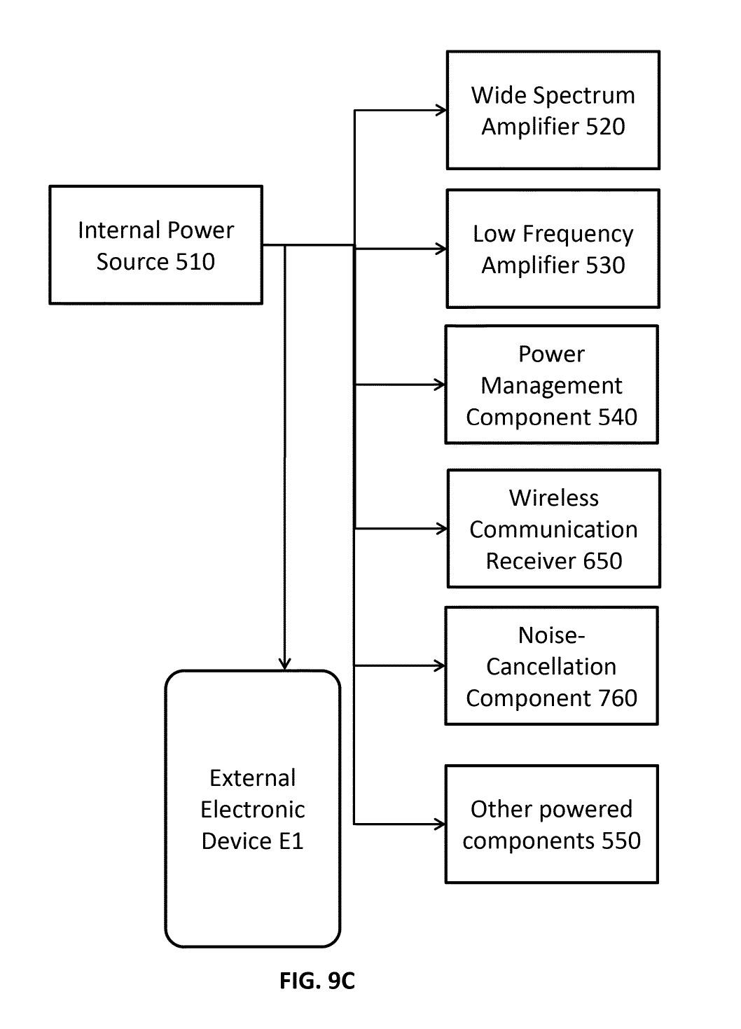

Turning now to FIG. 9A, a pair of headphones according to an exemplary embodiment of the present invention is generally designated 700. Headphones 700 may include similar components to headphones 600 described above, such as first speaker unit 502a having annular padding 503a and second speaker unit 502b having annular padding 503b interconnected with band 504. As shown, headphones 700 may be electronically coupled with external device E1 via power transferring cable 507 so that electrical power may be transferred from headphones 700 to external electronic device E1, as described further herein.

Still referring to FIG. 9A, and referring additionally to FIG. 9B, headphones 700 may include power port 508 for receiving an adapter portion of power transferring cable 507. As shown, headphones 700 may also include audio input port 506 for receiving a portion of an audio signal cable.

Still referring to FIG. 9A and FIG. 9B, and referring additionally to FIG. 9C, a schematic diagram of headphones 700 is shown. Headphones 700 may include wide spectrum amplifier 520, low frequency amplifier 530, power management component 540, and wireless communication receiver 650 as described above. Headphones 700 may also include an internal power source 710 for providing electrical power to various components of headphones 700. Internal power source 710 may have a similar configuration to internal power sources 510 and 610 described above, but may be configured to accommodate additional on-board electrically-powered components, as described further herein. For example, internal power source 710 may be a 3.7V, 1800 m-Ah Li-ion battery.

Headphones 700 may additionally include a noise-cancellation component 760. Noise cancellation component 760 may be configured to produce an electrical signal and resultant sound that attenuates, e.g., minimizes or cancels out, targeted noise such as ambient noise or noise generated as a result of operation of headphones 700. In this manner, noise-cancellation component 760 may be one or more circuit elements configured to analyze a waveform associated with a target noise, generate an inverse waveform, and scale said inverse waveform to a similar amplitude to the target noise. Noise-cancellation component 760 may be selectively activated by a user, for example, through an actuator 762 such as a knob, button, dial, or toggle, to name a few. An indicator 764, such as an LED or other source of illumination, may be provided to indicate an active or inactive status of noise-cancellation component 760. In embodiments, noise-cancellation component 760 may be configured for automatic operation upon connection of internal power source 710 to headphones 700. In embodiments, noise-cancellation component 760 may be configured for automatic operation upon detection of target noise at a certain level, e.g., decibels.

In this regard, headphones 700 may be provided with power management component 540 such that the internal power supply 710 of headphones 700 may supply electrical power to external electronic device E1 connected via power transfer cable 507, e.g., in a charging operation, and may simultaneously supply electrical power to native electrically-powered components of headphones 600 (e.g., power management component 540, wide spectrum amplifier 520, low frequency amplifier 530, wireless communication receiver 650, noise cancellation component 760, and/or other electrically-powered components 550). In embodiments, internal power supply 710 may supply electrical power to native electrically-powered components of headphones 700 and not to external electronic device E1. In embodiments, internal power supply 710 may supply electrical power to external electronic device E1 and not to native electrically-powered components of headphones 500.

Power management component 540 may be configured to monitor one or more conditions relating to external electronic device E1 and act to apportion an amount of electrical power to external electronic device E1 in response, as described above with respect to headphones 500 and 600.

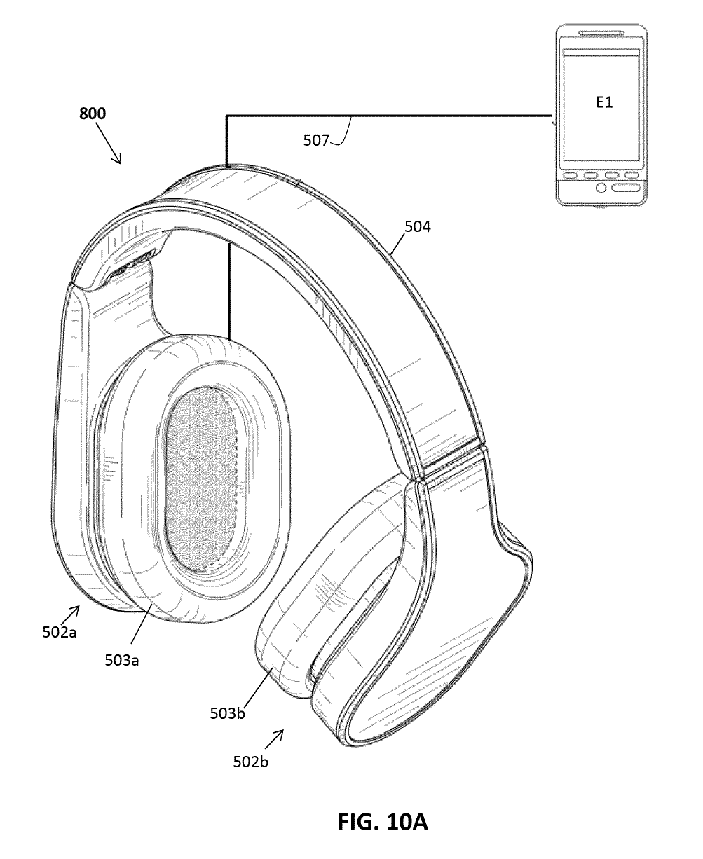

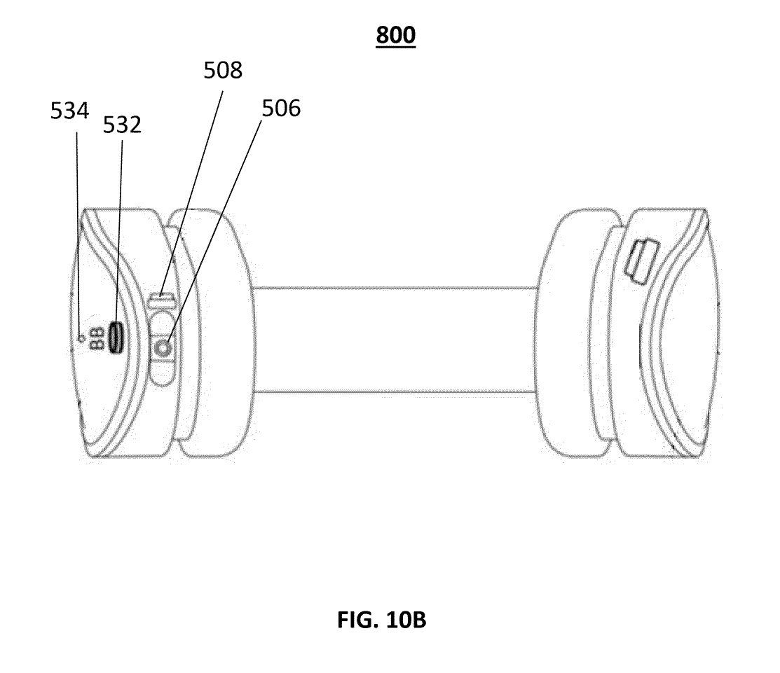

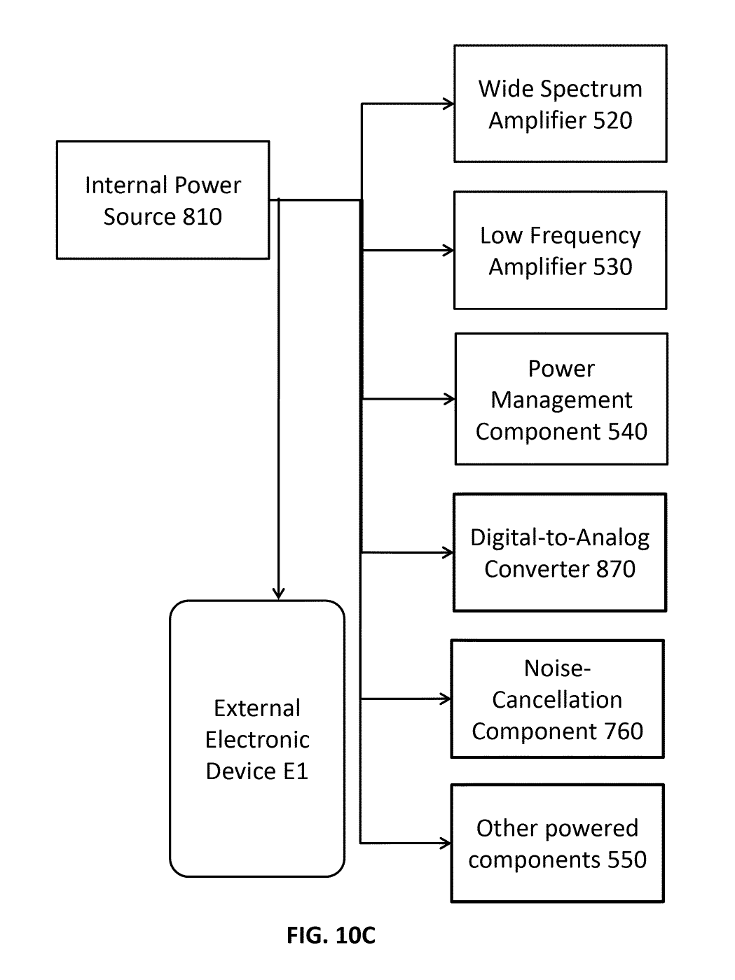

Turning now to FIG. 10A, a pair of headphones according to an exemplary embodiment of the present invention is generally designated 800. Headphones 800 may include substantially similar components to headphones 500 described above, such as first speaker unit 502a having annular padding 503a and second speaker unit 502b having annular padding 503b and interconnected with band 504. As shown, headphones 800 may be electronically coupled with external device E1 via power transferring cable 507 so that electrical power may be transferred from headphones 800 to external electronic device E1, as described further herein.

Still referring to FIG. 10A, and referring additionally to FIG. 10B, headphones 800 may include power port 508 for receiving an adapter portion of power transferring cable 507.

Still referring to FIG. 10A and FIG. 10B, and referring additionally to FIG. 10C, a schematic diagram of headphones 800 is shown. Headphones 800 may include wide spectrum amplifier 520, low frequency amplifier 530, and power management component 540. Headphones 800 may also include an internal power source 810 for providing electrical power to various components of headphones 800. Internal power source 810 may have a similar configuration to internal power sources 510, 610, and 710 described above, but may be configured to accommodate additional on-board electrically-powered components, as described further herein. For example, internal power source 810 may be a 3.7V, 2200 m-Ah Li-ion battery.

Headphones 800 may additionally include a digital-to-analog converter 870 for receiving a digital input audio signal, e.g., a stream of electronic data associated with audio content. In conventional headphones, a digital audio signal is converted to an analog audio signal by an external electronic device and sent through an audio input cable to one or more speaker units of the headphones. In contrast, the digital-to-analog-converter 870 of headphones 800 allows a digital input audio signal to be transmitted directly to headphones 800 for conversion to an analog audio signal at headphones 800.

Such a configuration of headphones 800 may provide several advantages. Some external electronic devices, e.g., external electronic device E1, are capable of transmitting electronic data simultaneously with electrical power through a common port, e.g., a USB-type or Lightning port. In this regard, a common electrical connector, e.g., power transfer cable 507, may be utilized to transfer electrical power from headphones 800 to external electronic device E1, while simultaneously transmitting an electronic data stream corresponding to media content from external electronic device E1 to headphones 800 through power transferring cable 507. Such a solution minimizes the amount of electronic connectors that a user must carry for interoperation of headphones 800 and external electronic device E1. Further, the conversion of the digital audio signal at the headphones 800 (as opposed to prior to transmission through an electronic connector cable) may minimize any potential loss of audio signal quality during transmission.

In embodiments, headphones 800 are provided with power management component 540 such that the internal power supply 810 of headphones 800 may supply electrical power to external electronic device E1 connected via power transfer cable 507, e.g., in a charging operation, and may simultaneously supply electrical power to native electrically-powered components of headphones 800 (e.g., power management component 540, wide spectrum amplifier 520, low frequency amplifier 530, and/or digital-to-analog converter 870). In embodiments, internal power supply 810 may supply electrical power to native electrically-powered components of headphones 800 and not to external electronic device E1. In embodiments, internal power supply 810 may supply electrical power to external electronic device E1 and not to native electrically-powered components of headphones 800.

Power management component 540 may be configured to monitor one or more conditions relating to external electronic device E1 and act to apportion an amount of electrical power to external electronic device E1 in response, as described above with respect to headphones 500, 600, and 700.

In embodiments, other components may be provided with headphones 800, for example, wireless communication receiver 650, noise-cancellation component 760, and/or other electrically-powered components 550, to name a few.

It will be understood that that any of the above steps and/or elements may be combined, separated, in any combination and/or separation thereof, and/or taken in any order. For ease, the steps are described as being sequential and/or in order. This is merely for ease and is not in any way meant to be a limitation.

Now that exemplary embodiments of the present disclosure have been shown and described in detail, various modifications and improvements thereon will become readily apparent to those skilled in the art.

What is claimed:

1. A pair of headphones, comprising:
a first speaker unit configured to provide audio output and comprising an internal power source;
a second speaker unit configured to provide audio output and electronically connected with the first speaker unit, the first speaker unit and the second speaker unit physically connected with a band;
a port located on one of the first speaker unit and the second speaker unit, the port in electrical communication with the internal power source and configured to receive electronic data;
an internal digital-to-analog converter disposed within one of the first speaker unit and the second speaker unit and electronically connected between the port and the first and second speaker units; and
an internal power management component disposed within one of the first speaker unit and the second speaker unit and operatively connected between the internal power source and the port to direct electrical power to flow from the internal power source to an external electronic device that is electronically connected to one of the first speaker unit and the second speaker unit via the port while simultaneously directing electrical power to flow from the internal power source to one or more other powered components of the headphones;
wherein the port is configured to transmit electrical power and receive electronic data simultaneously.

2. The pair of headphones of claim 1, wherein the one or more other powered components of the headphones comprise a wireless communication receiver.

3. The pair of headphones of claim 1, wherein the one or more other powered components of the headphones comprises an amplifier.

4. The pair of headphones of claim 1, wherein the internal power management component is configured to control an output voltage of the internal power source.

5. The pair of headphones of claim 1, wherein the internal power management component is configured to determine an amount of electrical power in the internal power source.

6. The pair of headphones of claim 5, wherein the internal power management component is configured to prevent electrical power from flowing through the port if the internal power source is below a predetermined threshold level.

7. The pair of headphones of claim 1, wherein the port is configured to receive a portion of a power transferring cable.

8. The pair of headphones of claim 7, wherein the port is configured as one of the group comprising: a USB-A port, a mini USB-A port, a micro USB-A port, a USB-B port, a mini USB-B port, a micro USB-B port, and a Lightning Port.

9. The pair of headphones of claim 1, wherein the port is configured to receive electronic data associated with audio content.

10. The pair of headphones of claim 1, wherein the one or more other powered components of the headphones comprises a noise-cancellation component.

11. The pair of headphones of claim 1, wherein the power management component is a digital signal processor.

12. The pair of headphones of claim 1, wherein the power management component is configured to apportion a predetermined amount of electrical power to an external electronic device electrically coupled with the port.

13. A pair of headphones, comprising:
a first speaker unit configured to provide audio output and comprising an internal power source;
a second speaker unit configured to provide audio output and electronically connected with the first speaker unit, the first speaker unit and the second speaker unit physically connected with a band;
a port located on one of the first speaker unit and the second speaker unit, the port in electrical communication with the internal power source and configured to receive electronic data;
a wireless communication receiver disposed within one of the first speaker unit and the second speaker unit and electronically connected to the internal power source; and
an internal power management component disposed within one of the first speaker unit and the second speaker unit and operatively connected between the internal power source and the port to direct electrical power to flow from the internal power source to an external electronic device that is electronically connected to one of the first speaker unit and the second speaker unit via the port while simultaneously directing electrical power to flow from the internal power source to one or more other powered components of the headphones.

14. The pair of headphones of claim 13, wherein the one or more other powered components of the headphones comprises an amplifier.

15. The pair of headphones of claim 13, wherein the one or more other powered components of the headphones comprises a noise-cancellation component.

16. The pair of headphones of claim 13, wherein the one or more other powered components of the headphones comprises an internal digital-to-analog converter.

17. A pair of headphones, comprising:
a first speaker unit configured to provide audio output and comprising an internal power source;
a second speaker unit configured to provide audio output and electronically connected with the first speaker unit, the first speaker unit and the second speaker unit physically connected with a band;
a port located on one of the first speaker unit and the second speaker unit, the port in electrical communication with the internal power source and configured to receive electronic data;
a noise-cancellation component electronically connected to the internal power source; and
an internal power management component disposed within one of the first speaker unit and the second speaker unit and operatively connected between the internal power source and the port to direct electrical power to flow from the internal power source to an external electronic device that is electronically connected to one of the first speaker unit and the second speaker unit via the port while simultaneously directing electrical power to flow from the internal power source to one or more other powered components of the headphones.

18. The pair of headphones of claim 17, wherein the one or more other powered components of the headphones comprises an amplifier.

19. The pair of headphones of claim 17, wherein the one or more other powered components of the headphones comprises a wireless communication receiver.

20. The pair of headphones of claim 17, wherein the one or more other powered components of the headphones comprises an internal digital-to-analog converter.
